(19) United States
(12) Patent Application Publication
(10) Pub. No.: US 2023/0345318 A1
(43) Pub. Date: Oct. 26, 2023

(54) METHOD AND APPARATUS OF CELL SWITCHING AND BEAM MANAGEMENT FOR SUPPORTING MULTI-TRANSMISSION AND RECEPTION POINT FUNCTION

(71) Applicant: ELECTRONICS AND TELECOMMUNICATIONS RESEARCH INSTITUTE, Daejeon (KR)

(72) Inventor: Jae Heung KIM, Daejeon (KR)

(73) Assignee: ELECTRONICS AND TELECOMMUNICATIONS RESEARCH INSTITUTE, Daejeon (KR)

(21) Appl. No.: 18/304,180

(22) Filed: Apr. 20, 2023

(30) Foreign Application Priority Data
Apr. 26, 2022 (KR) 10-2022-0051388
Apr. 18, 2023 (KR) 10-2023-0050433

(51) Int. Cl. H04W 36/00

(52) U.S. Cl. CPC H04W 36/0072; H04W 36/0085

(57) ABSTRACT

A method of a terminal may comprise: performing a measurement operation on a radio channel; transmitting a result of the measurement operation to a serving cell; receiving a cell switching indication message from the serving cell; and performing communication with a target cell based on the cell switching indication message, wherein a cell switching operation according to the cell switching indication message is a medium access control (MAC)-based cell switching operation without radio resource control (RRC) reconfiguration.

### CROSS-REFERENCE TO RELATED APPLICATIONS

This application claims priority to Korean Patent Applications No. 10-2022-0051388, filed on Apr. 26, 2022, and No. 10-2023-0050433, filed on Apr. 18, 2023, with the Korean Intellectual Property Office (KIPO), the entire contents of which are hereby incorporated by reference.

### BACKGROUND

### 1. Technical Field

Exemplary embodiments of the present disclosure relate to a communication technique for using a high frequency band such as a millimeter wave band or above, and more particularly, to a technique for supporting terminal-centric mobility functions utilizing radio access points.

### 2. Related Art

In order to cope with the explosive increase in wireless data, a mobile communication system can support a wide system bandwidth. In order to support a wide system bandwidth, a 6 GHz to 90 GHz band may be considered as a transmission frequency band in a mobile communication system. In such a high frequency band, performance degradation of a received signal may occur due to path losses and reflections of radio waves. In this situation, a method of utilizing radio access points to improve terminal performance at a base station (or cell) boundary may be considered. The radio access point may refer to a transmission and reception point (TRP), remote radio head (RRH), relay, or repeater.

In a mobile communication system supporting a millimeter wave band (e.g., 6 GHz to 90 GHz band), use of a function split scheme, carrier aggregation scheme, dual connectivity scheme, and/or duplication transmission scheme may be considered rather than a method of deploying small base stations each implementing all radio protocol functions. In other words, a method of constructing a mobile communication system using a plurality of radio access points instead of small base stations may be considered. When the function split scheme is used, functions (e.g., radio protocol functions) of a base station may be processed as being split into a plurality of remote radio transmission/reception blocks and one centralized baseband processing function block.

In the mobile communication system supporting the function split, bi-casting, and/or duplication transmission scheme, there is a need for methods for a terminal to perform an operation of supporting mobility functions in a plurality of radio access points belonging to network nodes (e.g., base stations, eNBs, gNBs, cells, and/or the like) distinguished by different identifiers.

### SUMMARY

The present disclosure for solving the above-described problems is directed to providing a method and an apparatus for cell switching and beam management in a mobile communication system.

According to a first exemplary embodiment of the present disclosure, a method of a terminal may comprise: performing a measurement operation on a radio channel; transmitting a result of the measurement operation to a serving cell; receiving a cell switching indication message from the serving cell; and performing communication with a target cell based on the cell switching indication message, wherein a cell switching operation according to the cell switching indication message is a medium access control (MAC)-based cell switching operation without radio resource control (RRC) reconfiguration.

Each of the serving cell and the target cell may include one or more transmission and reception points (TRPs), and the serving cell and the target cell may belong to a same base station or different base stations.

The cell switching operation may mean a TRP switching operation or a beam switching operation.

The method may further comprise: receiving a cell switching list from a base station to which the serving cell belongs, wherein the measurement operation is performed on one or more cells indicated by the cell switching list.

The cell switching list may include at least one of a cell identifier, a TRP identifier, a beam identifier, or a transmission configuration indicator (TCI) state identifier (ID).

The method may further comprise: transmitting a cell switching request message to the target cell after performing the measurement operation, wherein the cell switching request message may be transmitted together with the result of the measurement operation or transmitted after transmitting the result of the measurement operation, and the cell switching request message may be a layer 1 (L1) message or a layer2 (L2) message.

The L1 message may be a random access (RA) preamble, a scheduling request, or an uplink reference signal.

The L2 message may be a Msg3 in a 4-step RA procedure or a MsgA payload in a 2-step RA procedure.

A radio resource for transmission of the cell switching request message may be pre-allocated in an RRC connection configuration procedure or an RRC connection reconfiguration procedure between a base station to which the serving cell belongs and the terminal.

The cell switching indication message may be a MAC control element (CE) or downlink control information (DCI).

The cell switching indication message may include at least one of information indicative of performing an operation of acquiring an uplink timing, information of the uplink timing, scheduling information, an identifier of the target cell, an identifier of a target TRP associated with the target cell, an identifier of a target beam associated with the target cell, an identifier of a serving beam associated with the serving cell, or combinations thereof.

The method may further comprise, when the cell switching indication message is received, performing an operation of acquiring an uplink timing for the target cell.

According to a second exemplary embodiment of the present disclosure, a method of a base station may comprise: receiving, from a terminal, a result of a measurement operation on a radio channel; determining whether to perform a cell switching operation based on the result of the measurement operation; and in response to determining that the cell switching operation is to be performed, transmitting a cell switching indication message to the terminal, wherein the result of the measurement operation is received by a serving cell belonging to the base station, the cell switching indication message is transmitted by the serving cell, the serving cell includes one or more transmission and reception points (TRPs), and the cell switching operation is a medium access control (MAC)-based cell switching operation without radio resource control (RRC) reconfiguration.

The method may further comprise: transmitting a cell switching list to the terminal, wherein the measurement operation of the terminal is performed on one or more cells indicated by the cell switching list.

The cell switching list may include at least one of a cell identifier, a TRP identifier, a beam identifier, or a transmission configuration indicator (TCI) state identifier (ID).

The method may further comprise: receiving a cell switching request message from the terminal, wherein the cell switching request message is a layer 1 (L1) message or a layer2 (L2) message.

The L1 message may be a random access (RA) preamble, a scheduling request, or an uplink reference signal, and the L2 message may be a Msg3 in a 4-step RA procedure or a MsgA payload in a 2-step RA procedure.

A radio resource for transmission of the cell switching request message may be pre-allocated in an RRC connection configuration procedure or an RRC connection reconfiguration procedure between the base station and the terminal.

The cell switching indication message may be a MAC control element (CE) or downlink control information (DCI).

The cell switching indication message may include at least one of information indicative of performing an operation of acquiring an uplink timing, information of the uplink timing, scheduling information, an identifier of the target cell, an identifier of a target TRP associated with the target cell, an identifier of a target beam associated with the target cell, an identifier of a serving beam associated with the serving cell, or combinations thereof.

According to the present disclosure, in a mobile communication system supporting the function split scheme, a procedure for managing and recovering a radio link, a procedure for configuring and changing a plurality of radio access points, and the like can be performed efficiently in consideration of a state of a terminal in access links between the terminal and one or more radio access points. The terminal may be mounted on a moving object (e.g., unmanned aerial vehicle, train, self-driving car, car using a navigation device, or the like). According to the above-described procedures, performance of downlink and/or uplink communication in the mobile communication system can be improved.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of an apparatus.

FIG. 3 is a conceptual diagram illustrating a first exemplary embodiment of operation states of a terminal in a communication system.

FIG. 4 is a conceptual diagram illustrating a first exemplary embodiment of a method for configuring bandwidth parts (BWPs) in a communication system.

FIG. 5 is a conceptual diagram illustrating a second exemplary embodiment of a communication system.

FIG. 6 is a conceptual diagram illustrating a first exemplary embodiment of a method of providing a service using a plurality of radio access points in a communication system.

FIG. 7A is a conceptual diagram illustrating a first exemplary embodiment of a method for providing a service by a radio access point controlled by a base station.

FIG. 7B is a conceptual diagram illustrating a second exemplary embodiment of a method for providing a service by a radio access point controlled by a base station.

FIG. 7C is a conceptual diagram illustrating a first exemplary embodiment of a method for providing a service by a radio access point controlled by a DU included in a base station to which the function split scheme is applied.

FIG. 7D is a conceptual diagram illustrating a second exemplary embodiment of a method for providing a service by a radio access point controlled by a DU included in a base station to which the function split scheme is applied.

FIG. 8 is a sequence chart illustrating a first exemplary embodiment of a cell/TRP/beam switching procedure in a communication system.

FIG. 9 is a sequence chart illustrating a second exemplary embodiment of a cell/TRP/beam switching procedure in a communication system.

FIG. 10 is a sequence chart illustrating a third exemplary embodiment of a cell/TRP/beam switching procedure in a communication system.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. ‘Configuration of information element(s) (e.g., parameter(s))’ may mean that the corresponding information element(s) are signaled. ‘Configuration of a resource (e.g., resource region)’ may mean that configuration information of the corresponding resource is signaled. The signaling may be performed based on at least one of system information (SI) signaling (e.g., transmission of system information block (SIB) and/or master information block (MIB)), RRC signaling (e.g., transmission of RRC parameters and/or higher layer parameters), MAC control element (CE) signaling, PHY signaling (e.g., transmission of downlink control information (DCI), uplink control information (UCI), and/or sidelink control information (SCI)), or a combination thereof.

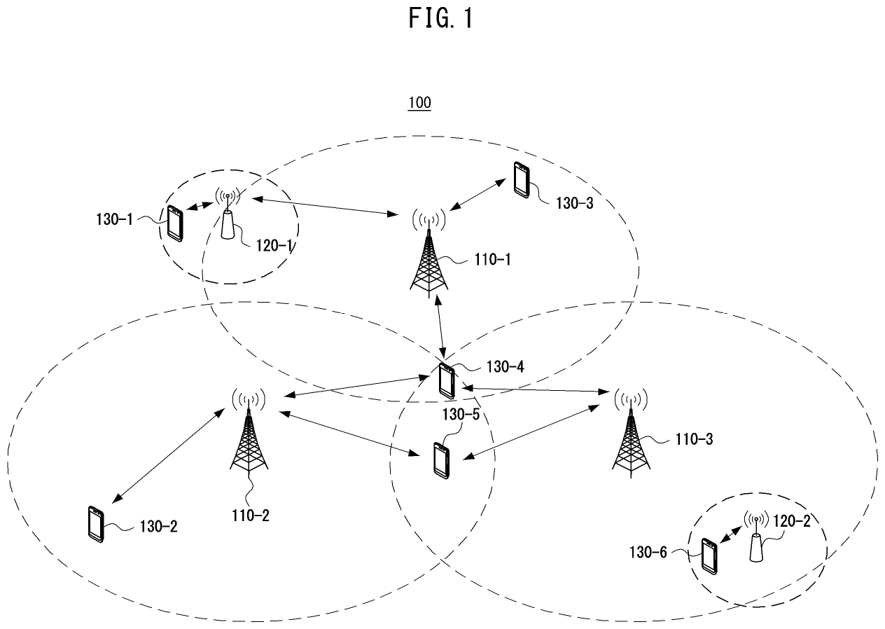

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

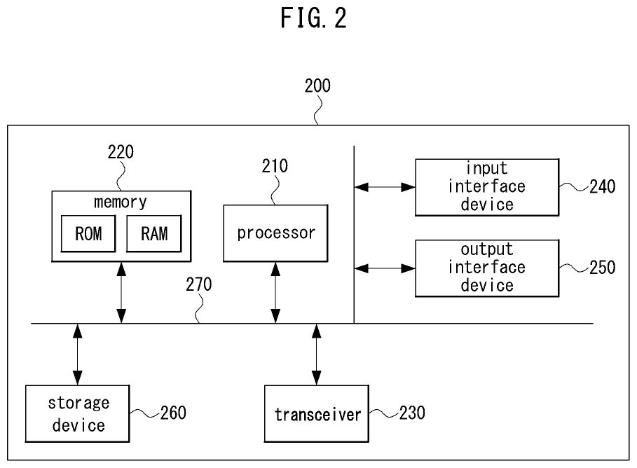

FIG. 2 is a block diagram illustrating a first exemplary embodiment of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to operations of the plurality of base stations 110-1, 110-2, 110-3, 120-1, and 120-2, operations supported by the plurality of base stations 110-1, 110-2, 110-3, 120-1, and 120-2, or the like. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

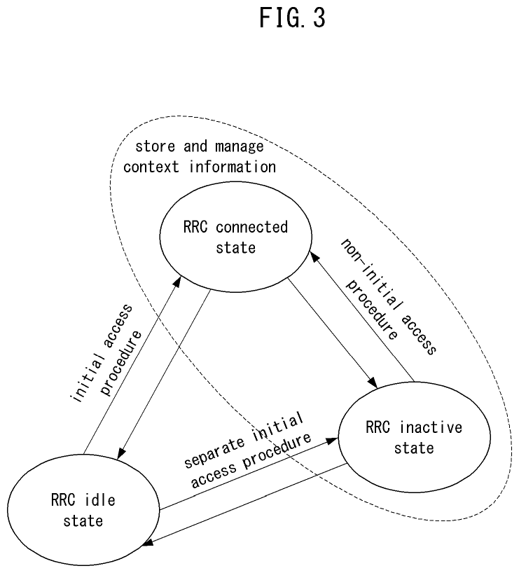

FIG. 3 is a conceptual diagram illustrating a first exemplary embodiment of operation states of a terminal in a communication system.

Referring to FIG. 3, in a radio resource control (RRC) layer of the communication system, states (e.g., operation states) of a terminal may be classified into an RRC connected state, RRC inactive state, and RRC idle state. When the terminal operates in the RRC connected state or the RRC inactive state, a base station of a radio access network (RAN) and the terminal may store and/or manage RRC connection configuration information, RRC context information, or access stratum (AS) context information of the terminal.

In the RRC connected state, the terminal may receive allocation information of physical layer control channels and/or reference signals necessary for maintaining RRC connection configuration and/or transmitting and receiving packets (e.g., data). The reference signal may be a reference signal for demodulating data, a reference signal for measuring a channel quality, and/or a reference signal for beamforming. The terminal in the RRC connected state may be able to transmit and receive packets (e.g., data) without additional delay. In the present disclosure, the packet may refer to data.

In the RRC inactive state, the terminal may perform a mobility management function corresponding to the RRC idle state. Although the terminal in the RRC inactive state is in a state of being connected to the base station, a data bearer for transmitting and receiving packets may not be configured in the terminal in the RRC inactive state, and functions such as the MAC layer may be inactivated in the terminal in the RRC inactive state. In order to transmit data, the terminal in the RRC inactive state may transition to the RRC connected state by performing a non-initial access procedure. Alternatively, the terminal in the RRC inactive state may transmit limited data allowed in the RRC inactive state. The limited data may be data having a limited size, data having a limited quality of service, and/or data belonging to a limited type of service.

From the perspective of the radio access network, a connection configured between the terminal in the RRC idle state and the base station may not exist. Connection configuration information and/or context information (e.g., RRC context information, AS context information) for the terminal in the RRC idle state may not be stored in the base station and/or a control function block of the radio access network. The terminal in the RRC idle state may perform an initial access procedure to transition to the RRC connected state. Although the terminal in the RRC idle state performs an initial access procedure to transition to the RRC connected state, the state of the terminal may transition from the RRC idle state to the RRC inactive state according to determination of the base station.

The terminal in the RRC idle state may transition to the RRC inactive state by performing an initial access procedure or a separate access procedure defined for transition to the RRC inactive state. When a limited service is provided to the terminal, the operation state of the terminal may transition from the RRC idle state to the RRC inactive state. Alternatively, the operation state of the terminal may transition from the RRC idle state to the RRC inactive state according to capability of the terminal.

The base station and/or the control function block of the radio access network may configure condition(s) by which the terminal can transition to the RRC inactive state in consideration of one or more of the type, capability, and/or service (e.g., service currently being provided, service to be provided) of the terminal, and may control the transition operation to the RRC inactive state based on the configured condition(s). When the base station allows transition to the RRC inactive state or when it is configured to be able to transition to the RRC inactive state, the operation state of the terminal may transition from the RRC connected state or the RRC idle state to the RRC inactive state.

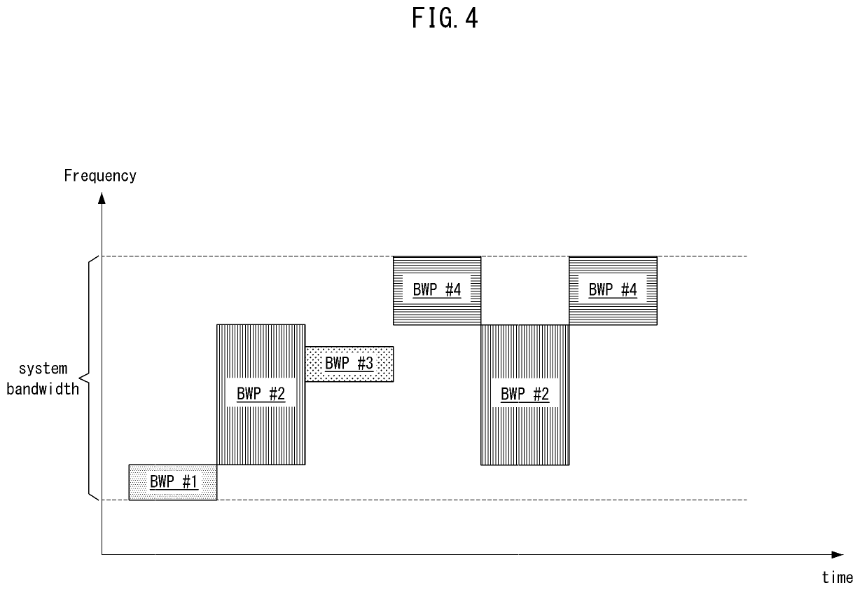

FIG. 4 is a conceptual diagram illustrating a first exemplary embodiment of a method for configuring bandwidth parts (BWPs) in a communication system.

Referring to FIG. 4, a plurality of bandwidth parts (e.g., BWPs #1 to #4) may be configured within a system bandwidth of the base station. The BWPs #1 to #4 may be configured not to be larger than the system bandwidth of the base station. The bandwidths of the BWPs #1 to #4 may be different, and different subcarrier spacings (SCSs) may be applied to the BWPs #1 to #4. For example, the bandwidth of the BWP #1 may be 10 MHz, and the BWP #1 may have a 15 kHz SCS. The bandwidth of the BWP #2 may be 40 MHz, and the BWP #2 may have a 15 kHz SCS. The bandwidth of the BWP #3 may be 10 MHz, and the BWP #3 may have a 30 kHz SCS. The bandwidth of the BWP #4 may be 20 MHz, and the BWP #4 may have a 60 kHz SCS.

The BWPs may be classified into an initial BWP (e.g., first BWP), an active BWP (e.g., activated BWP), and a default BWP. The terminal may perform an initial access procedure (e.g., access procedure) with the base station in the initial BWP. One or more BWPs may be configured through an RRC connection configuration message, and one BWP among the one or more BWPs may be configured as the active BWP. Each of the terminal and the base station may transmit and receive packets in the active BWP among the configured BWPs. Therefore, the terminal may perform a monitoring operation on control channels for packet transmission and reception in the active BWP.

The terminal may switch the operating BWP from the initial BWP to the active BWP or the default BWP. Alternatively, the terminal may switch the operating BWP from the active BWP to the initial BWP or the default BWP. The BWP switching operation may be performed based on an indication of the base station or a timer. The base station may transmit information indicating the BWP switching to the terminal using one or more of an RRC message, a MAC message (e.g., MAC control element (CE)), and a PHY message (e.g., DCI). The terminal may receive the information indicating the BWP switching from the base station, and may switch the operating BWP of the terminal to a BWP indicated by the received information.

When a random access (RA) resource is not configured in the active uplink (UL) BWP in the NR communication system, the terminal may switch the operating BWP of the terminal from the active UL BWP to the initial UL BWP in order to perform a random access procedure. The operating BWP may be a BWP in which the terminal performs communication (e.g., transmission and reception operation of a signal and/or channel).

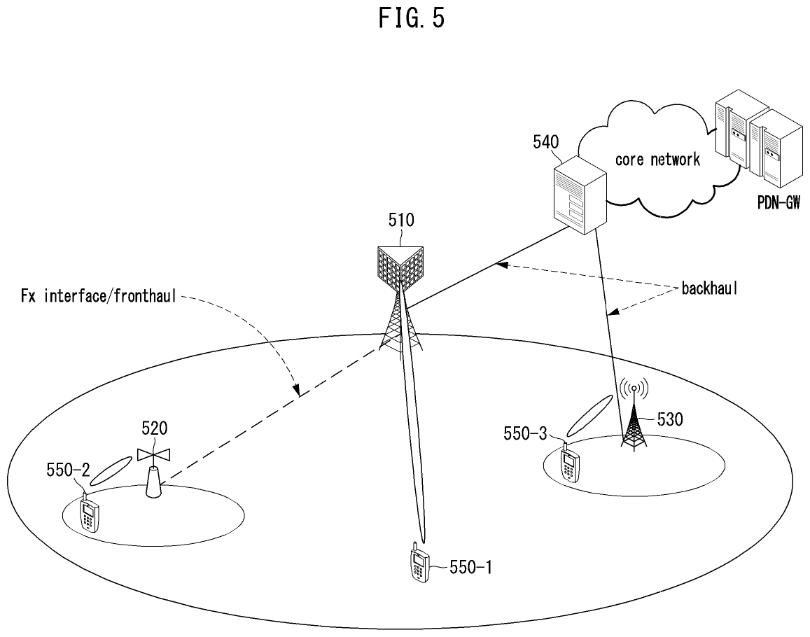

FIG. 5 is a conceptual diagram illustrating a second exemplary embodiment of a communication system.

Referring to FIG. 5, a communication system may include a core network and an access network. The core network supporting the 4G communication may include an MME, S-GW, P-GW, and the like. A function block supporting the S-GW and the MME may be referred to as an S-GW/MME 540. The core network supporting the 5G communication may include an AMF, UPF, PDN-GW, and the like. A function block supporting the UPF and the AMF may be referred to as a UPF/AMF 540. The access network may include a base station 510, radio access point 520, small base station 530, and terminals 550-1, 550-2, and 550-3. The base station 510 may mean a macro base station. The base station 510 and/or the small base station 530 may be connected to an end node of the core network through a backhaul. The end node may be the S-GW, UPF, MME, AMF, or the like.

The function split scheme may be applied to the base station 510 and the small base station 530. In this case, each of the base station 510 and the small base station 530 may include one central unit (CU) and one or more distributed units (DUs). The CU may be a logical node that performs functions of an RRC layer, service data application protocol (SDAP) layer, and/or packet data convergence protocol (PDCP) layer. The CU may control operations of one or more DUs. The CU may be connected to an end node of the core network using an S1 interface-based backhaul or an NG interface-based backhaul. The S1 interface-based backhaul may refer to a backhaul in the 4G communication system, and the NG interface-based backhaul may refer to a backhaul in the 5G communication system.

The DU may be a logical node that performs functions of a radio link control (RLC) layer, MAC layer, and/or PDCP layer. The DU may support one or more cells. The DU may be connected to the CU in a wired or wireless manner using an F1 interface. When a wireless scheme is used, a connection between the DU and the CU may be configured in an integrated access and backhaul (IAB) scheme.

Each of the base station 510 and the small base station 530 may be connected to the radio access point 520 in a wired or wireless manner using an Fx interface (or fronthaul). In the present disclosure, the base station (e.g., macro base station, small base station) may refer to a cell, DU, and/or the like. The radio access point may refer to a transmission and reception point (TRP), remote radio head (RRH), relay, or repeater. The TRP may perform at least one of a downlink transmission function and an uplink reception function. The radio access point 520 may perform only radio frequency (RF) functions.

Alternatively, the radio access point 520 may perform RF functions and some functions of the DU (e.g., some functions of a physical (PHY) layer and/or the MAC layer). Some functions of the DU, which are supported by the radio access point 520, may include lower functions of the PHY layer, functions of the PHY layer, and/or lower functions of the MAC layer. The Fx interface between the base station 510 or 530 and the radio access point 520 may be defined differently depending on the function(s) supported by the radio access point 520.

Each of the radio access point 520 of FIG. 5 and the base stations 110-1, 110-2, 110-3, 120-1, 120-2, 510, and 530 of FIGS. 1 and 5 may support OFDM, OFDMA, SC-FDMA, or NOMA-based downlink communication and/or uplink communication. Each of the radio access point 520 and the base stations 110-1, 110-2, 110-3, 120-1, 120-2, 510, and 530 may support beamforming functions using an antenna array in a transmission carrier of a millimeter wave band. In this case, a service through each beam may be provided without interference between beams within the base station. One beam may provide services for a plurality of terminals.

Each of the radio access point 520 and the plurality of base stations 110-1, 110-2, 110-3, 120-1, 120-2, 510, and 530 may perform MIMO transmission (e.g., single user (SU)-MIMO, multi user (MU)-MIMO, massive MIMO, etc.), coordinated multipoint (CoMP) transmission, carrier aggregation (CA) transmission, transmission in an unlicensed band, device-to-device (D2D) communication (or proximity services (ProSe), sidelink communication), and/or the like. Here, each of the plurality of terminals 130-1, 130-2, 130-3, 130-4, 130-5, 130-6, 550-1, 550-2, and 550-3 may perform operations corresponding to operations of the radio access point 520 and/or the plurality of base stations 110-1, 110-2, 110-3, 120-1, 120-2, 510, and 530 and/or operations supported by the radio access point 520 and/or the plurality of base stations 110-1, 110-2, 110-3, 120-1, 120-2, 510, and 530. For example, the second base station 110-2 may transmit a signal to the fourth terminal 130-4 based on the SU-MIMO scheme, and the fourth terminal 130-4 may receive the signal from the second base station 110-2 based on the SU-MIMO scheme. Alternatively, the second base station 110-2 may transmit signals to the fourth terminal 130-4 and the fifth terminal 130-5 based on the MU-MIMO scheme, and each of the fourth terminal 130-4 and the fifth terminal 130-5 may receive the signal from the second base station 110-2 based on the MU-MIMO scheme.

The first base station 110-1, the second base station 110-2, and the third base station 110-3 may transmit a signal to the fourth terminal 130-4 based on the CoMP scheme, and the fourth terminal 130-4 may receive the signal from the first base station 110-1, the second base station 110-2, and the third base station 110-3 based on the CoMP scheme. Each of the plurality of base stations 110-1, 110-2, 110-3, 120-1, and 120-2 may transmit and receive signals with the terminals 130-1, 130-2, 130-3, 130-4, 130-5, and 130-6 belonging to its own cell coverage based on the CA scheme. Each of the first base station 110-1, the second base station 110-2, and the third base station 110-3 may coordinate D2D communication between the fourth terminal 130-4 and the fifth terminal 130-5, and the fourth terminal 130-4 and the fifth terminal 130-5 may perform the D2D communication according to coordination of the second base station 110-2 and the third base station 110-3, respectively.

Hereinafter, operation methods of a communication node in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the communication system, the UPF (or, S-GW) may refer to an end communication node of the core network that exchanges packets (e.g., control information, data) with the base station. In the communication system, the AMF (or, MME) may refer to a communication node in the core network, which performs control functions in a radio access section (or, interface) of the terminal. Here, each of the backhaul link, fronthaul link, Xhaul link, DU, CU, BBU block, S-GW, MME, AMF, and UPF may be referred to as a different term according to a function of a communication protocol depending on a radio access technology (RAT) or a constituent function of the core network.

In order to perform a mobility support function and a radio resource management function, the base station may transmit a synchronization signal (e.g., synchronization signal/physical broadcast channel (SS/PBCH) block or synchronization signal block (SSB)) and/or a reference signal. In order to support multiple numerologies, frame formats supporting symbols having different lengths may be configured. In this case, the terminal may perform a monitoring operation on the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication system is configured, and/or a frame format applied to radio resources in which a synchronization symbol burst capable of identifying a cell in the NR communication system is transmitted.

The frame format may refer to information of configuration parameters (e.g., values of the configuration parameters, offset, index, identifier, range, periodicity, interval, duration, etc.) for a subcarrier spacing, control channel (e.g., CORESET), symbol, slot, and/or reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the base station 510 may transmit a synchronization signal and/or a reference signal so that a terminal located within its service coverage can discover the base station 510 to perform downlink synchronization maintenance, beam configuration, or link monitoring operations. The terminal 550-1 connected to the base station 510 (e.g., serving base station) may receive physical layer radio resource configuration information for connection configuration and radio resource management from the base station 510.

The physical layer radio resource configuration information may mean configuration parameters included in RRC control messages of the LTE communication system or the NR communication system. For example, the resource configuration information may include PhysicalConfigDedicated, PhysicalCellGroupConfig, PDCCH-Config(Common), PDSCH-Config(Common), PDCCH-ConfigSIB1, ConfigCommon, PUCCH-Config(Common), PUSCH-Config(Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of the base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, slot, and subframe that exist within one radio frame (e.g., a frame of 10 ms) may be configured differently.
Configuration information of transmission a frequency and a frame format of a base station
   Transmission frequency configuration information: information on all transmission carriers (i.e., cell-specific transmission frequency) in the base station, information on bandwidth parts (BWPs) in the base station, information on a transmission reference time or time difference between transmission frequencies of the base station (e.g., a transmission periodicity or offset parameter indicating the transmission reference time (or time difference) of the synchronization signal), etc.
   Frame format configuration information: configuration parameters of a mini-slot, slot, and subframe having a different symbol length according to a subcarrier spacing
Configuration information of a downlink reference signal (e.g., channel state information-reference signal (CSI-RS), common reference signal (Common-RS), etc.)
   Configuration parameters such as a transmission periodicity, transmission position, code sequence, or masking (or scrambling) sequence for a reference signal, which are commonly applied within the coverage of the base station (or beam).
Configuration information of an uplink control signal
   Configuration parameters such as a sounding reference signal (SRS), uplink beam sweeping (or beam monitoring) reference signal, uplink grant-free radio resources (or, preambles), etc.
Configuration information of a physical downlink control channel (e.g., PDCCH)
   Configuration parameters such as a reference signal for PDCCH demodulation, beam common reference signal (e.g., reference signal that can be received by all terminals within a beam coverage), beam sweeping (or beam monitoring) reference signal, reference signal for channel estimation, etc.
Configuration information of a physical uplink control channel (e.g., PUCCH)
Scheduling request signal configuration information
Configuration information for a feedback (acknowledgement (ACK) or negative ACK (NACK)) transmission resource in a hybrid automatic repeat request (HARD) procedure
Number of antenna ports, antenna array information, beam configuration or beam index mapping information for application of beamforming techniques
Configuration information of a downlink signal and/or an uplink signal (or uplink access channel resource) for beam sweeping (or beam monitoring)
Configuration information of parameters for beam configuration, beam recovery, beam reconfiguration, or radio link re-establishment operation, beam change operation within the same base station, reception signal of a beam triggering handover execution to another base station, timers controlling the above-described operations, etc.

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the present disclosure, ‘Resource-Config information’ may be a control message including one or more parameters of the physical layer radio resource configuration information. In addition, the ‘Resource-Config information’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group). A terminal group may include one or more terminals.

The configuration information included in the ‘Resource-Config information’ may be transmitted through one control message or different control messages according to the attributes of the configuration information. The beam index information may not express the index of the transmission beam and the index of the reception beam explicitly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station. For example, when a communication service is provided using beam configuration (e.g., beam pairing) between the base station and the terminal, the terminal may perform a search operation or a monitoring operation of a radio channel by using a synchronization signal (e.g., SS/PBCH block) and/or a reference signal (e.g., CSI-RS) of a beam configured with the base station, or a beam that can be received. Here, the expression that a communication service is provided through a beam may mean that a packet is transmitted and received through an active beam among one or more configured beams. In the NR communication system, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from system information or common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, procedure for recovering a radio link, procedure for detecting (or declaring) a radio link failure, and procedure for re-establishing a radio link according to the RLM operation may be performed by functions of a layer 1 (e.g., physical layer), a layer 2 (e.g., MAC layer, RLC layer, PDCP layer, etc.), and/or a layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, beam common reference signal, or terminal (or terminal group) specific reference signal (e.g., dedicated reference signal allocated to a terminal (or terminal group)). Here, the common reference signal may be used for channel estimation operations of all terminals located within the corresponding base station or beam coverage (or service area). The dedicated reference signal may be used for a channel estimation operation of a specific terminal or a specific terminal group located within the base station or beam coverage.

Accordingly, when the base station or the beam (e.g., configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication system may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. In a handover procedure, synchronization reconfiguration procedure, or connection reconfiguration procedure, the base station may transmit a dedicated control message including the configuration information of the common reference signal to the terminal.

The configured beam information may include at least one of a configured beam index (or identifier), configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and reference signal identifier.

In the present disclosure, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, MAC message, and PHY message, and may identify a base station with which the terminal performs a beam monitoring operation, radio access operation, and/or control (or data) packet transmission and reception operation.

The result of the measurement operation (e.g., beam monitoring operation) for the beam may be reported through a physical layer control channel (e.g., PUCCH) and/or a MAC message (e.g., MAC CE, control PDU). Here, the result of the beam monitoring operation may be a measurement result for one or more beams (or beam groups). For example, the result of the beam monitoring operation may be a measurement result for beams (or beam groups) according to a beam sweeping operation of the base station.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam, a change from the deactivated beam to the active beam, a change from the primary beam to the secondary beam, a change from the secondary beam to the primary beam, a change from the primary beam to the reserved (or candidate) beam, or a change from the reserved (or candidate) beam to the primary beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more among scheduling information (e.g., radio resource allocation information, modulation and coding scheme (MCS) information), feedback information (e.g., channel quality indication (CQI), precoding matrix indicator (PMI), HARQ ACK, HARQ NACK), resource request information (e.g., scheduling request (SR)), result of the beam monitoring operation for supporting beamforming functions, TCI state ID, and measurement information for the active beam (or deactivated beam).

The physical layer control channel may be configured to be transmitted through the primary beam of downlink. In this case, the feedback information may be transmitted and received through the primary beam, and data scheduled by the control information may be transmitted and received through the secondary beam. The physical layer control channel may be configured to be transmitted through the primary beam of uplink. In this case, the resource request information (e.g., SR) and/or the feedback information may be transmitted and received through the primary beam.

In the procedure of allocating the plurality of beams (or the procedure of configuring the TCI states), the allocated (or configured) beam indexes, information indicating a spacing between the beams, and/or information indicating whether contiguous beams are allocated may be transmitted and received through a signaling procedure between the base station and the terminal. The signaling procedure of the beam allocation information may be performed differently according to status information (e.g., movement speed, movement direction, location information) of the terminal and/or the quality of the radio channel. The base station may obtain the status information of the terminal from the terminal. Alternatively, the base station may obtain the status information of the terminal through another method.

The radio resource information may include parameter(s) indicating frequency domain resources (e.g., center frequency, system bandwidth, PRB index, number of PRBs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The condition (e.g., reference value) indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to-noise ratio (SNR), a signal-to-interference ratio (SIR), or the like.

Meanwhile, in the NR communication system using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth. For example, BWPs may be configured as follows.

Measurement operations (e.g., monitoring operations) for beam (or TCI state) or radio link management may be performed at the base station and/or the terminal. The base station and/or the terminal may perform the measurement operations (e.g., monitoring operations) according to parameter(s) configured for the measurement operations (e.g., monitoring operations). The terminal may report a measurement result according to parameter(s) configured for measurement reporting.

When a reception quality of a reference signal according to the measurement result meets a preconfigured reference value and/or a preconfigured timer condition, the base station may determine whether to perform a beam (or, radio link) management operation, a beam switching operation, or a beam deactivation (or, activation) operation according to a beam blockage situation. When it is determined to perform a specific operation, the base station may transmit a message triggering execution of the specific operation to the terminal. For example, the base station may transmit a control message for instructing the terminal to execute the specific operation to the terminal. The control message may include configuration information of the specific operation.

When a reception quality of a reference signal according to the measurement result meets a preconfigured condition (e.g., reference value or threshold) and/or a preconfigured timer condition, the terminal may report the measurement result to the base station. Alternatively, the terminal may transmit to the base station a control message triggering a beam (or, radio link) management operation, a beam switching operation (or a TCI state ID change operation, a property change operation), or a beam deactivation operation (or a beam activation operation) according to a beam blockage situation. The control message may request to perform a specific operation.

A basic procedure for beam (or TCI state) management through the radio link monitoring may include a beam failure detection (BFD) procedure, a beam recovery (BR) request procedure, and the like for a radio link. An operation of determining whether to perform the beam failure detection procedure and/or the beam recovery request procedure, an operation triggering execution of the beam failure detection procedure and/or the beam recovery request procedure, and a control signaling operation for the beam failure detection procedure and/or the beam recovery request procedure may be performed by one or more of the PHY layer, the MAC layer, and the RRC layer.

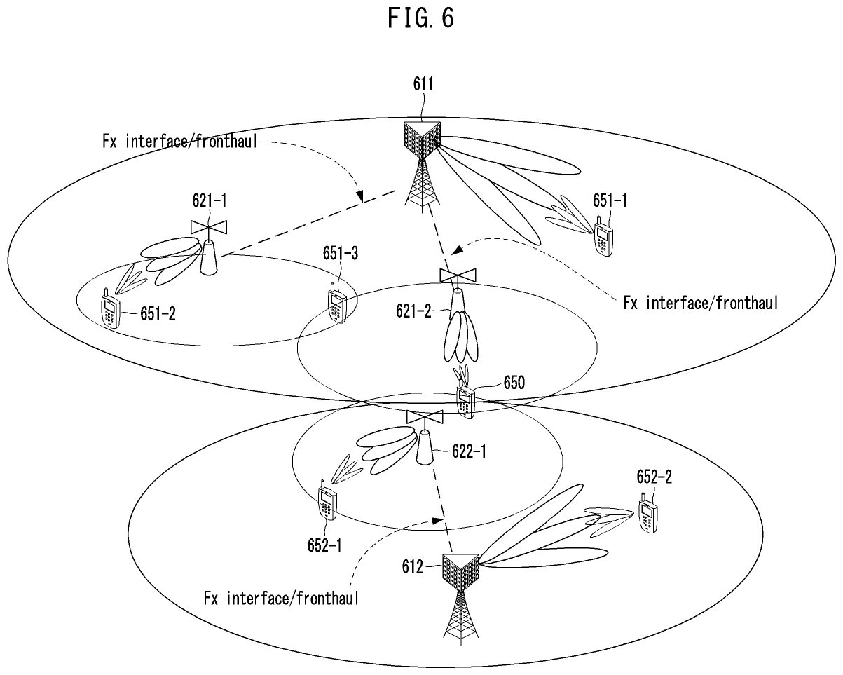

FIG. 6 is a conceptual diagram illustrating a first exemplary embodiment of a method of providing a service using a plurality of radio access points in a communication system.

Referring to FIG. 6, base stations 611 and 612 may provide services to radio access points 621-1, 621-2, and 622-1 within service coverages through wired interfaces or wireless interfaces. Interfaces between the base station 611 and the radio access points 621-1 and 621-2 within the service coverage of the base station 611 may be provided in a wired or wireless manner. An interface between the base station 612 and the radio access point 622-1 within the service coverage of the base station 612 may be provided in a wired or wireless manner. The function split scheme may be applied to the base stations 611 and 612. In this case, each of the base stations 611 and 612 may be configured as two or more nodes (e.g., CU and DU(s)) that perform radio protocol functions of each of the base stations 611 and 612.

The base stations 611 and 612 and the radio access points 621-1, 621-2, and 622-1 may each provide services to terminals 650, 651-1, 651-2, 651-3, 652-1, and 652-2 within each service coverage through wireless links (e.g., Uu interfaces). Transmission frequencies (or frequency bands) of the radio access points 621-1 and 621-2 within the base station 611 may be the same or different. When the radio access points 621-1 and 621-2 use the same frequency, the radio access points 621-1 and 621-2 may operate as the same cell having the same physical cell ID (PCI) or different cells having different PCIs.

When the radio access points 621-1 and 621-2 operate at the same frequency, the radio access points 621-1 and 621-2 provide a service to the terminal 651-3 in a single frequency network (SFN) scheme. The SFN scheme may refer to a scheme in which one or more radio access points simultaneously transmit the same data to the terminal using the same frequency. In order to provide the SFN scheme-based service, each of the radio access points 621-1 and 621-2 may transmit a downlink channel and/or signal to the terminal 653-1 by using the same resource (e.g., physical resource blocks (PRBs)) in the frequency and time domains. The terminal 653-1 may receive the downlink channel and/or signal from each of the radio access points 621-1 and 621-2 by using a beam (or radio resource) corresponding to a beam identifier (e.g., TCI state identifier) of each of the radio access points 621-1 and 621-2. Here, the expression ‘downlink channel and/or signal’ may refer to at least one of a downlink channel and a downlink signal. The TCI state identifier may refer to a TCI state ID or a TCI state index.

The radio access points 621-1 and 621-2 operating at the same frequency may not use the SFN scheme. In this case, each of the radio access points 621-1 and 621-2 may transmit a downlink channel and/or signal to the terminal 651-3 using a different resource (e.g., PRBs) in the frequency and time domains. The terminal 653-1 may receive the downlink channel and/or signal from each of the radio access points 621-1 and 621-2 by using a beam (or radio resource) corresponding to a beam identifier (e.g., TCI state identifier) of each of the radio access points 621-1 and 621-2.

The radio access points 621-1 and 621-2 may have different PCIs. In other words, the radio access points 621-1 and 621-2 may operate as different cells. The fact that the radio access points 621-1 and 621-2 operate as different cells may mean that the base station 611 includes two or more cells having different PCIs, and each of the radio access points 621-1 and 621-2 is a lower node (or radio access point) of a cell corresponding thereto. Alternatively, the fact that the radio access points 621-1 and 621-2 operate as different cells may mean that two or more cells having different PCIs exist within one DU included in the base station 611 to which the function split scheme is applied, and each of the radio access points 621-1 and 621-2 is a lower node (or radio access point) of a cell corresponding thereto.

When the radio access points 621-1 and 621-2 belong to different cells within a base station or a DU of the base station, a service for a terminal (e.g., terminal in the RRC connected state) that does not support carrier aggregation functions may be provided by one radio access point.

The base station may provide a service to a terminal using one or more cells or one or more radio access points. The base station to which the function split scheme is applied may include one CU and a plurality of DUs, and each of the plurality of DUs may provide a service to a terminal using one or more cells or one or more radio access points.

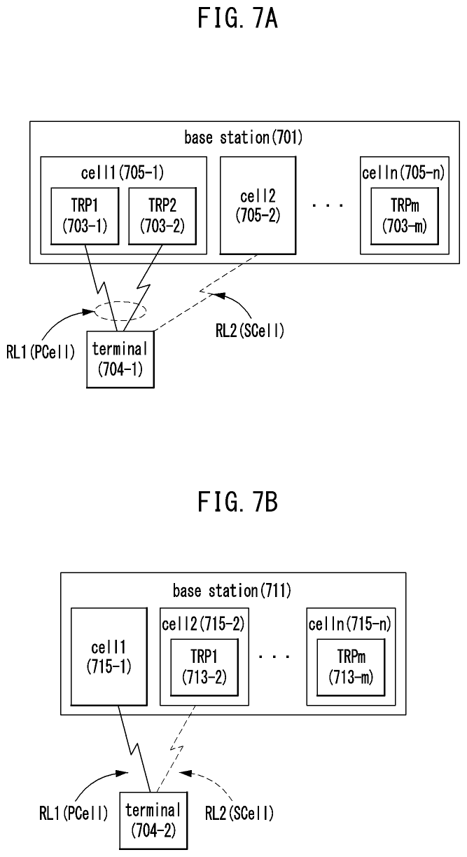

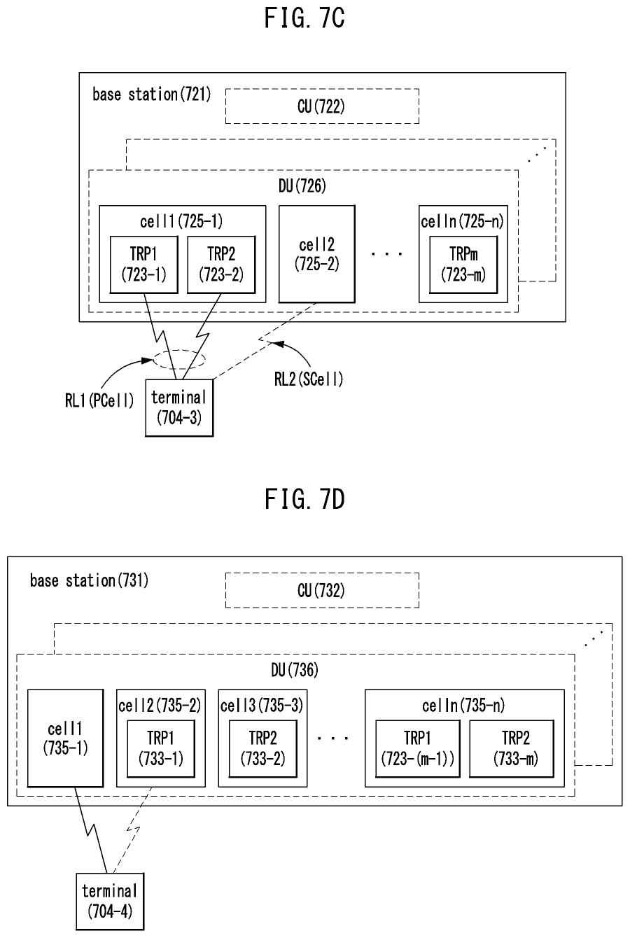

FIG. 7A is a conceptual diagram illustrating a first exemplary embodiment of a method for providing a service by a radio access point controlled by a base station, FIG. 7B is a conceptual diagram illustrating a second exemplary embodiment of a method for providing a service by a radio access point controlled by a base station, FIG. 7C is a conceptual diagram illustrating a first exemplary embodiment of a method for providing a service by a radio access point controlled by a DU included in a base station to which the function split scheme is applied, and FIG. 7D is a conceptual diagram illustrating a second exemplary embodiment of a method for providing a service by a radio access point controlled by a DU included in a base station to which the function split scheme is applied.

Referring to FIGS. 7A to 7D, a radio access point may be referred to as a TRP. In the exemplary embodiments of FIGS. 7A and 7B, base stations 701 and 711 to which the function split scheme is not applied may include one or more cells 705 and 715 and/or one or more TRPs 703 and 713. The base stations 701 and 711 may operate cells 705-2 and 715-1 to which the TRP 703 and 713 are not applied and/or cells 705-1, 705-n, 715-2, and 715-n to which the TRP 703 and 713 are applied, respectively. One cell may be configured using one or more TRPs.

In the exemplary embodiments of FIGS. 7C and 7D, base stations 721 and 731 to which the function split scheme is applied may include one CU 722 and 732 and one or more DUs 726 and 736, respectively. Although cells 725 and 735 and TRPs 723 and 733 are shown as respectively belonging to the DUs 726 and 736, this may not indicate that all functions of the cells 725 and 735 and the TRPs 723 and 733 are respectively performed or implemented by the DUs 726 and 736. In terms of the structure of the communication system, the DU 726 or 736 and the cell 725 or 735 may belong to different layers, and the DU 726 or 736 and the TRP 723 or 733 may belong to different layers. The cell 725 or 735 within the DU 726 or 736 may perform functions of the RLC layer or layers (e.g., MAC layer, and/or PHY layer) below the RLC layer among radio protocol layers.

The base station 721 or 731 to which the function split scheme is applied may include cell 725-2 or 735-1 to which TRP 723 or 733 is not applied and/or cell 725-1, 725-n, 735-2, 735-3, or 735-n to which the TRP(s) are applied. One DU 726 or 736 may include one or more cells 725 and 735 and/or one or more TRPs 723 and 733.

The same PCI may be applied to a plurality of TRPs constituting one cell. Each of a plurality of TRPs within a cell may be distinguished by a TRP index (or TRP ID, TRP identifier). Different PCIs may be applied to TRPs belonging to different cells.

The base station may provide a service to a terminal 704 within a coverage of the cell and/or TRP using radio links (e.g., RL1 and RL2). The base stations 701, 711, 721, and 731 may not configure a carrier aggregation (CA) function to the terminal 704 in the RRC connected state. In this case, the service for the terminal 704 may be provided by one cell (or primary cell (PCell)) through the RL1. When the CA function is configured in the terminal 704 in the RRC connected state, the service for the terminal 704 may be provided through the RL1 for the PCell and the RL2 for a secondary cell (SCell).

Function blocks of the TRP may belong to the same cell or different cells. The same cell may mean cell(s) having the same PCI. Different cells may mean cells having different PCIs. The same PCI may be applied to the TRPs 703-1 and 703-2 belonging to the same cell. The same PCI may be applied to the TRPs 723-1 and 723-2 belonging to the same cell. Different PCIs may be applied to TRPs 703-m, 713-2, 713-m, 723-m, 733-1, and 733-2 belonging to different cells. The TRPs belonging to different cells may operate at the same frequency or different frequencies. In the case that the TRPs operate at different frequencies, the TRPs may have different PCIs. In other words, TRPs with different PCIs may belong to different cells.

When a dual connectivity (DC) function is not configured for a terminal in the RRC connected state, the terminal may configure an RRC connection with one base station, and a service for the terminal may be provided by the one base station. When a CA function is not configured in the terminal, the service for the terminal may be provided by one cell (e.g., PCell) through the RL1. When the DC function is not configured in the terminal in the RRC connected state, the terminal may perform MAC layer functions using only one MAC entity.

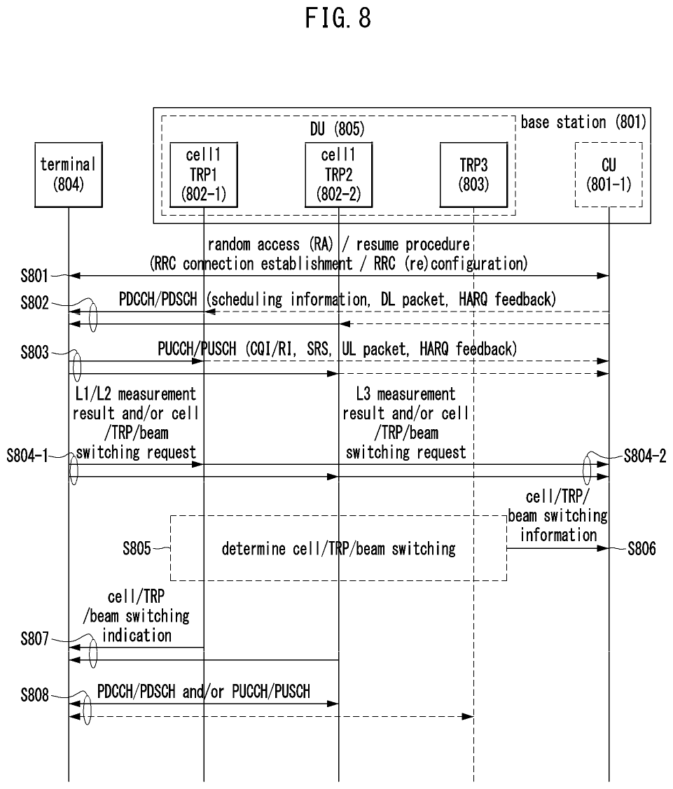

FIG. 8 is a sequence chart illustrating a first exemplary embodiment of a cell/TRP/beam switching procedure in a communication system.

Referring to FIG. 8, TRPs belonging to one cell and having the same PCI may provide a service to a terminal. A base station 801 to which the function split scheme is applied may include a CU 801-1 and a DU 805. When the function split scheme is not applied, the base station 801 may include one or more cells. The DU 805 of the base station 801 to which the function split scheme is applied may include one or more cells. The cell may provide a service to the terminal 804 using one or more TRPs 802 and 803. The TRP 803 (hereinafter, ‘TRP3’) may belong to the same cell (i.e., ‘cell 1’) as a TRP 802-1 (hereinafter, TRP1′) and/or a TRP 802-2 (hereinafter TRP2′). Alternatively, the TRP3 may belong to a cell different from the cell 1 within the base station 801 or the DU 805. The base station to which the TRP3 belongs may be the same as or different from the base station to which the TRP1 and the TRP2 belong. In the present disclosure, the expression ‘cell/TRP/beam’ may mean at least one of a cell, TRP, or beam.

The terminal 804 in the RRC idle state or RRC inactive state may perform a radio access procedure with the base station 801 (S801). The radio access procedure may include a random access procedure and/or a resume procedure. In the step S801, the terminal 804 may transition to the RRC connected state by performing an RRC connection establishment procedure or an RRC connection (re)configuration procedure with the base station 801 (or CU 801-1). In the step S801, the terminal 804 may monitor and/or measure downlink radio channels of the cells (or TRPs) 802 and 803, and based on a result of the monitoring and/or measurement, the terminal 804 may select the best cell (or, best TRP) and/or best downlink beam, and perform the radio access procedure (e.g., random access procedure, resume procedure) using an a radio resource of an uplink channel radio, which corresponds to the selected beam. The best cell may mean an optimal cell, the best TRP may mean an optimal TRP, and the best downlink beam may mean an optimal downlink beam.

In the present disclosure, a beam, beam identifier, or beam ID may refer to an index (or identifier) for distinguishing a beam for a downlink channel (e.g., PDCCH, PDSCH), a downlink signal (e.g., SSB, CSI-RS, tracking reference signal (TRS), positioning reference signal (PRS), DM-RS), an uplink channel (e.g., PUCCH, PUSCH), and/or an uplink signal (e.g., DM-RS, SRS). The index for distinguishing a beam may mean a TCI state index (e.g., TCI state ID) for configuring or distinguishing the beam. The TCI state index may be configured by the RRC layer, and may be controlled or indicated by a MAC CE of the MAC layer and/or a DCI of the PHY layer.

The terminal 804 may transmit a downlink channel measurement result, service request, and/or capability information (e.g., terminal capability information) to the base station 801 (or CU 801-1) in the radio access procedure. The channel measurement result may include a channel quality (e.g., RSRP, RSRQ, RSSI, SNR, SIR, Eb/No, etc.), SSB index, and/or RS index for a signal (e.g., SSB or RS) transmitted by the base station (or cell or TRP) requiring the selection of radio link and/or beam.

The base station 801 (or CU 801-1) may receive the channel measurement result for the cells (or TRPs) 802 and 803, service request, and/or capability information from the terminal 804, and may generate RRC configuration information necessary for providing a service requested by the terminal 804 based on the channel measurement result, service request, and/or capability information. The base station 801 (or CU 801-1) may transmit an RRC connection control message (e.g., RRC reconfiguration message, RRC release message, RRC resume message, etc.) including the RRC configuration information to the terminal 804. The RRC connection control message may include information of configuration parameters of each layer of the radio protocol. The RRC connection control message may be transmitted using a cell (or TRP) and/or a beam (or TCI state ID) selected by the terminal 804. The terminal 804 may receive the RRC connection control message from the base station 801 (or CU 801-1), and may configure parameters of each layer of the radio protocol, which are necessary for service provision, by using information included in the RRC connection control message.

In the step S801, the base station 801 (or the CU 801-1) may provide the terminal 804 with information on the cell(s)/TRP(s)/beam(s) providing the service. In the step S801, DC and CA functions may not be configured in the terminal 804 in the RRC connected state. In this case, the service for the terminal 804 may be provided by one TRP 802-1, 802-2, or 803 or two TRPs 802-1 and 802-1 belonging to the same cell (e.g., cell 1). The terminal 804 may identify configuration parameters for the two TRPs 802-1 and 802-2 included in the RRC connection control message. In this case, the terminal 804 may receive PDCCH(s) (e.g., DCI(s)) and/or a PDSCH (e.g., downlink (DL) packet) from the two TRPs 802-1 and 802-2. Scheduling information of the DL packet may be included in the DCI.

In a single-DCI mode, the terminal 804 may receive the same DCI from the two TRPs 802-1 and 802-2. In this case, the DL packet may be scheduled by the same two DCIs. In a multi-DCI mode, the terminal 804 may receive independent DCI from each of the two TRPs 802-1 and 802-2. In this case, the DL packet may be scheduled by the independent DCIs. To improve DCI reception performance, the terminal may repeatedly receive the same DCI through search spaces associated with different CORESETs of the TRPs. As another method for improving DCI reception performance, the DCI may be transmitted in one search space (or CORESET) using different beams. Alternatively, the terminal may receive the same DCI in a scheduled radio resource using different TCI state IDs. In this case, the terminal may receive the same DCI based on the SFN scheme.

The terminal 804 in the RRC connected state, in which DC and CA functions are not configured, may transmit a PUCCH (e.g., UCI) and/or PUSCH (e.g., UL packet) to two TRPs 802-1 and 802-2 belonging to the same cell (S803). To improve the performance of UL communication, the terminal 804 may repeatedly transmit the same PUCCH and/or the same PUSCH using uplink radio resources configured for different beams or uplink radio resources scheduled for different TCI state IDs to the TRPs 802-1 and 802-2.

In the step S804 (e.g., S804-1 and S804-2), the terminal 804 may periodically or aperiodically report measurement results for cells (e.g., different cells) and/or TRPs (e.g., different TRPs). The step S804 may be performed based on an RRC control message of the base station 801 (or CU 801-1) and/or a MAC CE of the DU 805. The MAC CE of the DU 805 may be control information of the MAC layer of the DU 805. In the step S804, the terminal 804 may determine whether radio channel quality(ies) of the cells/TRPs/beams satisfy a preconfigured reference, and based on a result of the determination, the terminal 804 may transmit a control message (e.g., RRC control message, MAC CE, DCI, PDCCH field, PDCCH parameter, or the like) requesting to change, recover, or reconfigure current cell(s), current TRP(s), or current beam(s). The current cell may mean a serving cell, the current TRP may mean a serving TRP, and the current beam may mean a serving beam. The serving TRP may be associated with the serving cell. In other words, the serving TRP may belong to the serving cell. The serving beam may be associated with the serving cell and/or the serving TRP. In other words, the serving beam may belong to the serving cell and/or the serving TRP. In the present disclosure, ‘changing’ may be used in the same meaning as or similar meaning to ‘switching’. For example, a cell change operation and a cell switching operation may be the same operation.

In the step S804-1, the terminal 804 may report L1 and/or L2 measurement result(s) to the MAC layer (e.g., MAC entity) of the DU 805. In the S804-2, L3 measurement result(s) may be reported to the RRC layer of the base station 801 (or CU 801-1). The L1 and/or L2 measurement result(s) reported by the terminal 804 may include one or more information elements listed in Table 1 below.

TABLE 1
Information elements

Instantaneous result (e.g., instantaneous measurement result of radio
channel quality) for SSB(s) and/or reference signal(s) measured by
the PHY layer (L1) of the terminal
Measurement result (e.g., CQI) for radio link(s)
Measurement result monitored by the L2 layer (e.g., RLC layer and/
or MAC layer) of the terminal based on the L1 instantaneous
measurement results during a time period (or period corresponding
to a timer). The result of L2 filtering on the L1 instantaneous
measurement results.
Performance measurement result in the L2 of the terminal

The L2 performance measurement result(s) may include at least one of a packet error rate (PER), block error rate (BLER), ARQ retransmission rate, ARQ (re)transmission failure rate, HARQ retransmission rate, HARQ (re)transmission failure rate, number of occurrences of beam failure detection (BFD), number of beam failure recovery (BFR) failures (or failure rate), or number of occurrences of radio link failure (RLF). The number of occurrences of BFD may mean the number of occurrences of BFD within a unit time. The number of occurrences of BFR failure may mean the number of BFR failures within a unit time. The number of occurrences of RLF may mean the number of RLFs within a unit time. Each of the L1 measurement operation, L1 measurement result reporting, L2 measurement operation, and L2 measurement result reporting may be performed for each cell/TRP/beam.

The DU 805 may request (or instruct) the terminal 804 to report L1 and/or L2 measurement result(s) for the serving TRP, active TRP, and/or specific TRP (or target TRP). In this case, the DU 805 may indicate an identifier, beam identifier, measurement object identifier, and/or type of measurement result parameter (or measurement result format) of the specific TRP (e.g., target TRP) which is a measurement target. The target TRP may be associated with a target cell. In other words, the target TRP may belong to the target cell. A target beam may be associated with the target cell and/or the target TRP. In other words, the target beam may belong to the target cell and/or the target TRP.

For the L1 and/or L2 measurement operation and measurement result reporting in the step S804, the base station 801 (or CU 801-1) may configure measurement reference(s) and/or measurement reporting reference(s) shown in Table 2 below by using a signaling message (e.g., RRC control message). The measurement reference(s) may refer to measurement condition(s). The measurement reporting reference(s) may mean refer to measurement reporting condition(s). A reference value may mean a threshold value.

TABLE 2
Measurement reference(s) and/or measurement reporting reference(s)

A case when a quality of a radio channel for a serving cell (or, active
TRP or serving TRP) is equal to or less than a reference value
A case when a quality of a radio channel for a serving cell (or, active
TRP or serving TRP) during a time corresponding to a predefined timer
(e.g., TRP-MaintainTimer) is equal to or less than a reference value
A case when the terminal is located at a boundary of a service coverage
of a serving cell (or, active TRP or serving TRP)
A case when a transmission frequency, frequency band, and/or BWP of
a detected TRP satisfies a priority for supporting the multi-TRP function
A case when a quality of a radio channel of a detected TRP (or target
TRP) is greater than or equal to a preconfigured reference value
A case when a quality of a radio channel of a detected TRP (or target
TRP) is greater than or equal to a reference value for a time
corresponding to a predefined timer (e.g., TRP_AddTimer)
A case when a difference between a radio channel quality of a serving
cell (or active TRP or serving TRP) and a radio channel quality of a
target TRP (or detected TRP) is greater than or equal to a reference value
A case when a random access procedure for an active TRP (or serving
TRP) fails
A case when a beam failure detection (BFD) for a serving cell (or
active TRP or serving TRP) is declared
A case when a BFR procedure for an active TRP (or serving TRP) fails

When one or more conditions listed in Table 2 are satisfied, the terminal 804 may perform the L1 measurement operation, L1 measurement result reporting, L2 measurement operation, and/or L2 measurement result reporting. When one or more conditions listed in Table 2 are satisfied, when a preconfigured TRP change condition (or reference) is satisfied, or when the terminal determines that a change of the serving TRP (or active TRP) is required, the terminal 804 may request to release functions of the serving TRP (or active TRP) and/or change the serving TRP (or active TRP).

In the step S804, the DU 805 may receive, from the terminal 804, the control message to request to change the TRP, L1 measurement result, and/or L2 measurement result. In the step S805, the DU 805 may determine whether to change the cells/TRPs/beams belonging to the cell and having the same PCI based on the control message requesting cell/TRP/beam switching, L1 measurement result, and/or L2 measurement result.

The DU 805 (e.g., MAC entity within the DU 805) may determine to switch the cell(s)/TRP(s)/beam(s) providing the service to the terminal 804 (S805). In this case, the DU 805 may transmit information on the cell/TRP/beam switching to the base station 801 (or the CU 801-1) (S806). The step S806 may be selectively performed. For example, the step S806 may be omitted according to a policy (or determination) of the communication system (or communication network). The DU 805 may transmit a control message indicating the cell/TRP/beam switching to the terminal 804 (S807).

The message indicating the cell/TRP/beam switching transmitted from the DU 805 to the terminal 804 in the step S807 may be a DCI and/or MAC CE. The message may include an identifier and/or a beam identifier of the TRP. The terminal 804 may receive the message indicating the cell/TRP/beam switching from the DU 805. When switching from the TRP1 802-1 and TRP2 802-2 to the TRP2 802-2 and TRP3 803 is performed, the terminal 804 may perform communication (e.g., DL communication and/or UL communication) with the TRP2 802-2 and the TRP3 803 (S808). In other words, the TRP2 802-2 and the TRP3 803 may provide a service to the terminal 804. The TRP2 802-2 and the TRP3 803 may operate as serving TRPs for the terminal 804 in the step S808.

The above-described cell/TRP/beam switching procedure may be performed when the TRP3 803 belongs to the same cell (e.g., one cell having the same PCI) together with the TRP1 802-1 and the TRP2 802-2.

In the exemplary embodiment of FIG. 8, the control message exchanged between the terminal 804 and the DU 805 for the cell/TRP/beam measurement indication, cell/TRP/beam measurement reporting, cell/TRP/beam switching request, and/or cell/TRP/beam switching indication may be field(s) (e.g., parameter(s)) of control channel(s) (e.g., PDCCH, PUCCH, DCI, UCI) and/or MAC CE(s). The MAC CE may be configured in form of a MAC protocol data unit (PDU) together with a MAC (sub)header. When a separate MAC CE parameter is not required, a control message including only a MAC subheader and/or logical channel ID (LCD) representing or indicating a specific operation may be used.

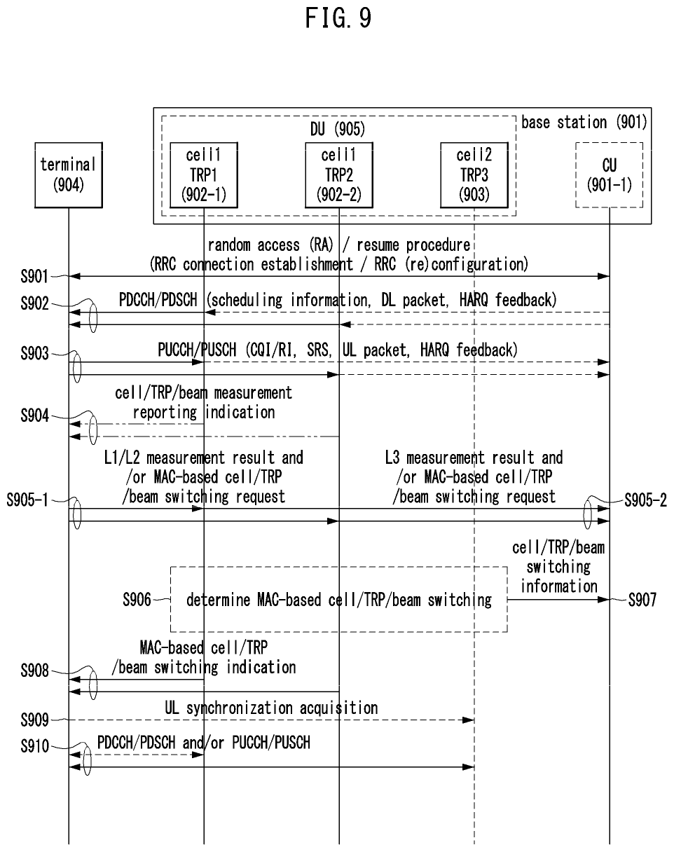

FIG. 9 is a sequence chart illustrating a second exemplary embodiment of a cell/TRP/beam switching procedure in a communication system.

Referring to FIG. 9, a base station 901 to which the function split scheme is applied may include a CU 901-1 and a DU 905. When the function split scheme is not applied, the base station 901 may include one or more cells. The DU 905 of the base station 901 to which the function split scheme is applied may include one or more cells. The cell may provide a service to a terminal 904 using one or more TRPs 902 and 903. The TRP1 902-1 and the TRP2 902-2 may belong to a cell 1, and the TRP3 903 may belong to a cell 2. The cell 1 and the cell 2 may have different PCIs. The cell 1 and the cell 2 may belong to the same base station or different base stations.

The terminal 904 in the RRC idle state or the RRC inactive state may perform a radio access procedure with the base station 901 (S901). The radio access procedure may include a random access procedure and/or a resume procedure. In the step S901, the terminal 904 may transition to the RRC connected state by performing an RRC connection establishment procedure or an RRC connection (re)configuration procedure with the base station 901 (or CU 901-1). In the step S901, the terminal 904 may monitor and/or measure DL radio channel(s) of the cell(s) (or TRPs 902 and 903), and based on results of the monitoring and/or measurement, the terminal 904 may select the best cell (or, TRP) and/or perform the radio access procedure (e.g., random access procedure or resume procedure) using a radio resource of a UL channel, which corresponds to the selected beam. The best cell may refer to an optimal cell, the best TRP may refer to an optimal TRP, and the best DL beam may refer to an optimal DL beam.

The terminal 904 may transmit DL channel measurement result(s), service request, and/or capability information (e.g., terminal capability information) to the base station 901 (or CU 901-1) in the radio access procedure. The channel measurement result may include a channel quality (e.g., RSRP, RSRQ, RSSI, SNR, SIR, Eb/No. etc.), SSB index, and/or RS index for a signal (e.g., SSB, RS) transmitted by the base station (or cell, TRP) requiring the selection of radio link and/or beam.

The base station 901 (or CU 901-1) may receive the channel measurement result for the cells (or TRPs) 902 and 903, service request, and/or capability information from the terminal 904, and may generate RRC configuration information required for providing a service requested by the terminal 904 based on the channel measurement result, service request, and/or capability information. The base station 901 (or CU 901-1) may transmit an RRC connection control message (e.g., RRC reconfiguration message, RRC release message, RRC resume message, etc.) including the RRC configuration information to the terminal 904. The RRC connection control message may include information of configuration parameters of each layer of the radio protocol. The RRC connection control message may be transmitted using the cell (or TRP) and/or beam (or TCI state ID) selected by the terminal 904. The terminal 904 may receive the RRC connection control message from the base station 901 (or CU 901-1), and may configure parameters of each layer of the radio protocol, which are required for providing the service, by using information included in the RRC connection control message.

In the step S901, the base station 901 (or CU 901-1) may provide, to the terminal 904, information on the cell(s) and/or TRP(s) providing the service and/or a cell/TRP/beam switching list. The cell/TRP/beam switching list may include at least one of information on cell(s) capable of cell switching based on the L1 measurement result and/or L2 measurement result, information on TRP(s) capable of TRP switching based on the L1 measurement result and/or L2 measurement result, or information on beam(s) capable of beam switching based on the L1 measurement result and/or the L2 measurement result. The Cell/TRP/beam switching may refer to an L1-based cell/TRP/beam switching, L2-based cell/TRP/beam switching, L1 and L2-based cell/TRP/beam switching, or MAC-based cell/TRP/beam switching.

The DU 905 may independently perform the cell switching operation, TRP switching operation, and/or beam switching operation. The cell switching may refer to switching between cells belonging to the same DU or different DUs. The TRP switching may refer to switching between TRPs belonging to the same cell and/or switching between TRPs belonging to different cells (e.g., different cells within the same DU or different DUs). The beam switching may refer to switching between beams for the same cell, switching between beams for different cells, switching between beams for the same TRP, and/or switching between beams for different TRPs. The base station 901 may allow the terminal 904 and/or the DU 905 to switch cells, TRPs, and/or beams belonging to the cell/TRP/beam switching list by transmitting the cell/TRP/beam switching list. The cell/TRP/beam switching list may include at least one of cell identifier(s) (e.g., PCI(s)), TRP identifier(s), beam identifier(s), or TCI state ID(s).

In the step S901, DC and CA functions may not be configured in the terminal 904 in the RRC connected state. In this case, the service for the terminal 904 may be provided by one TRP 902-1, 902-2, or 903 or two TRPs 902-1 and 902 belonging to the same cell (e.g., cell 1). The terminal 904 may identify configuration parameters for the two TRPs 902-1 and 902-2, which are included in the RRC connection control message. In this case, the terminal 904 may receive PDCCH(s) (e.g., DCI) and/or a PDSCH (e.g., DL packet) from the two TRPs 902-1 and 902-2 (S902). Scheduling information of the DL packet may be included in the DCI.

In the step S902, the terminal 904 may receive the DCI(s) from the two TRPs 902-1 and 902-2 based on a single-DCI mode or a multi-DCI mode. In order to improve DCI reception performance, repeated DCI transmission may be performed. The terminal 904 may transmit a PUCCH and/or PUSCH, and the base station 901 may receive the PUCCH and/or PUSCH from the terminal 904 (S903). The step S903 may be performed identically or similarly to the step S803 in the exemplary embodiment of FIG. 8.

The DU 905 (e.g., MAC layer or MAC entity) may determine a specific cell/specific TRP/specific beam for the cell/TRP/beam switching, and may instruct the terminal 904 to perform L1 measurement, L1 measurement result reporting, L2 measurement, and/or L2 measurement result reporting for the specific cell/TRP/beam (S904). The DU 905 may instruct the terminal 904 to perform the L1 measurement, L1 measurement result reporting, L2 measurement, and/or L2 measurement result reporting for cells/TRPs/beams belonging to the cell/TRP/beam switching list configured by the base station 901 (or CU 901-1). The cell/TRP/beam switching list may be indicated in the RRC connection configuration procedure between the terminal and the base station in the step S901. Alternatively, the cell/TRP/beam switching list may be indicated in an RRC connection reconfiguration procedure between the terminal and the base station after the step S901. In other words, the cells/TRPs/beams indicatable by the DU 905 in the step S904 may be limited to cells/TRPs/beams belonging to the cell/TRP/beam switching list and/or cells/TRPs/beams independently switchable by the DU 905. The control message transmitted from the DU 905 to the terminal 904 in the step S904 may include at least one of an identifier, beam identifier, measurement object identifier, or type of measurement result parameter (or, measurement result format) of the specific TRP (or target TRP) which is a measurement target.

In the step S904, the terminal 904 may receive the control message (e.g., cell/TRP/beam measurement reporting indication) from the DU 905, and may identify information element(s) included in the control message. Based on the RRC control message of the base station 901 (or the CU 901-1) and/or the control message of the DU 905 received in the step S904, the terminal 904 may perform a measurement operation (e.g., L1 measurement operation and/or L2 measurement operation) on the cell, TRP, and/or beam. The terminal 904 may periodically or aperiodically report measurement results (e.g., L1 measurement result and/or L2 measurement result) (S905). The measurement result of the terminal 904 may be transmitted to the CU 901-1 through the serving cell/serving TRPs 902-1 and 902-2.

In the step S905, the terminal 905 may determine whether a radio channel quality of the cell, TRP, and/or beam satisfies a preconfigured reference, and based on a result of the determination result, the terminal 905 may transmit a control message (e.g., RRC control message, MAC CE, DCI, PDCCH field, PDCCH parameter) requesting to change, recover, or reconfigure the current cell, TRP, and/or beam. The current cell may refer to a serving cell, the current TRP may refer to a serving TRP, and the current beam may refer to a serving beam.

In a step S905-1, the L1 measurement result and/or the L2 measurement result may be reported to the MAC layer (e.g., MAC entity) of the DU 905. In a step S905-2, the L3 measurement result may be reported to the RRC layer of the base station 901 (or CU 901-1). The L1 measurement result and/or the L2 measurement result reported by the terminal 904 may include one or more information elements listed in Table 1 above. In the step S905, the terminal 904 may transmit an L1/L2-based cell/TRP/beam switching request message (e.g., MAC-based cell/TRP/beam switching request message) to the DU 905. The L1/L2 based cell/TRP/beam switching request message may be transmitted through the serving cell/serving TRPs 902-1 and 902-2. The L1/L2 based cell/TRP/beam switching request message may include at least one of the identifier of the target cell, identifier of the target TRP, beam identifier, measurement result for the target cell, measurement result for the target TRP, or measurement result for the beam.

In the step S905-1, the DU 905 may receive the L1/L2 based cell/TRP/beam switching request message from the terminal 904. In the step S905-2, the DU 905 may transmit or notify some or all information elements included in the L1/L2 based cell/TRP/beam switching request message of the terminal 904 to the base station 901 (or the CU 901-1). Among the information elements included in the L1/L2 based cell/TRP/beam switching request message, the information element(s) transmitted to the base station 901 may be selected by the DU 905.

In the exemplary embodiments of FIGS. 8 and 9, each of the L1 measurement operation, the L1 measurement result reporting, the L2 measurement operation, and the L2 measurement result reporting may be performed for each cell, TRP, and/or beam. In order to perform the L1 and/or L2 measurement operation and measurement result reporting in the step S905, the base station 901 (or CU 901-1) may use a signaling message (e.g., RRC control message) to configure the measurement reference(s) and/or measurement reporting reference(s) described in Table 2 above.

When one or more conditions listed in Table 2 are satisfied, the terminal 904 may perform the L1 measurement operation, L1 measurement result reporting, L2 measurement operation, and/or L2 measurement result reporting. When one or more conditions listed in Table 2 are satisfied, when a preconfigured TRP change condition (or reference) is satisfied, or when the terminal determines that a change of the serving TRP (or active TRP) is required, the terminal 904 may transmit, to the DU 905, a control message triggering or requesting MAC-based cell/TRP/beam switching, release of functions of the serving TRP (or active TRP), and/or change of the TRP in the step S905.

In the step S905, the terminal 905 may receive the control message requesting MAC-based cell/TRP/beam switching, control message requesting TRP switching, L1 measurement result, and/or L2 measurement result from the terminal 904. In a step S906, the DU 905 may determine whether to switch the TRPs and/or beams belonging to cell(s) having the same PCI, whether to switch the TRPs and/or beams belonging to cells having different PCIs, and/or whether to perform MAC-based cell switching based on the control message requesting MAC-based cell/TRP/beam switching, control message requesting TRP switching, L1 measurement result, and/or L2 measurement result. The MAC-based cell/TRP/beam switching operation (e.g., L1-based cell/TRP/beam switching operation, L2-based cell/TRP/beam switching operation) may refer to a cell/TRP/beam switching operation without RRC connection reconfiguration. The MAC-based cell/TRP/beam switching operation may refer to a cell switching operation including an L1-based cell/TRP/beam switching operation and/or an L2-based cell/TRP/beam switching operation.

The DU 905 may determine to perform the MAC-based cell/TRP/beam switching operation (S906). In this case, the DU 905 may transmit a control message indicative of performing the MAC-based cell/TRP/beam switching operation to the base station 901 (or the CU 901-1) (S907). The DU 905 may transmit a control message (e.g., scheduling information) indicative of performing the MAC-based cell/TRP/beam switching operation to the terminal 904 (S908).

The control message transmitted by the DU 905 in the step S908 may be a MAC CE and/or DCI. The control message indicative of performing the MAC-based cell/TRP/beam switching operation may include information element(s) for the target cell (or target TRP). The control message may include one or more information elements listed in Table 3 below.

TABLE 3
Information elements

Information indicative of performing an acquisition operation of an
uplink timing (e.g., timing advance (TA))
Scheduling information for uplink access (e.g., scheduling information
of a physical layer radio resource)
Identifier of a target cell, identifier of a target TRP, and/or identifier of a
target beam
Uplink timing adjustment information for a target cell and/or a target TRP
Downlink scheduling information for a target cell and/or a target TRP
Uplink scheduling information for a target cell and/or a target TRP
Identifier (or TCI state ID) of a downlink serving beam
Identifier (or TCI state ID) of an uplink serving beam

When the control message received in the step S908 indicates acquisition of an uplink timing or when the control message received in the step S908 includes scheduling information for uplink access, the terminal 904 may perform a procedure for acquiring a physical layer uplink timing (e.g., uplink transmission timing) for the target cell/target TRP 903 (S909). When the control message received in the step S908 does not indicate acquisition of an uplink timing or when the control message received in the step S908 includes adjustment information of a physical layer uplink timing for the target cell/target TRP 903, the terminal 904 may omit the step S909.

After the step S908 or S909, the terminal 904 may perform communication (e.g., DL communication and/or UL communication) with the target cell/target TRP 903 (S910). In other words, the cell/TRP3 903 may provide a service to the terminal 904. The target cell/target TRP 903 may operate as a serving cell/serving TRP for the terminal 904 (S910).

In the MAC-based cell/TRP/beam switching procedure, radio resources and/or parameters configured (or allocated) between the source cell/source TRP (e.g., serving cell/serving TRP) and the terminal 904 may be released when the control message (or scheduling information) of the step S908 is received by the terminal 904. The step S909 may be performed based on the RRC configuration by the base station 901 (or CU 901-1) and/or control of the DU 905. The step S909 may be a synchronization acquisition procedure for the target cell/target TRP. After acquiring synchronization with the target cell/target TRP in the step S909 or after DL communication is successfully completed in the step S910, the radio resources and/or parameters configured (or allocated) between the source cell/source TRP (e.g., serving cell/serving TRP) and the terminal 904 may be released (or deleted). The DL communication in the step S910 may include a PDCCH transmission/reception operation and/or a PDSCH transmission/reception operation.

In the exemplary embodiment of FIG. 9, the control message, which is exchanged between the terminal 904 and the DU 905 for indication of the target cell/target TRP/target beam measurement, measurement result reporting for the target cell/target TRP/target beam, and/or MAC-based cell/TRP/beam switching, may be field(s) (e.g., parameter(s)) of a control channel (e.g., PDCCH, PUCCH, DCI, UCI) and/or a MAC CE. The MAC CE may be configured in form of a MAC PDU together with a MAC (sub)header. When a separate MAC CE parameter is not required, a control message including a MAC subheader and/or LCD representing or indicating a specific operation may be used.

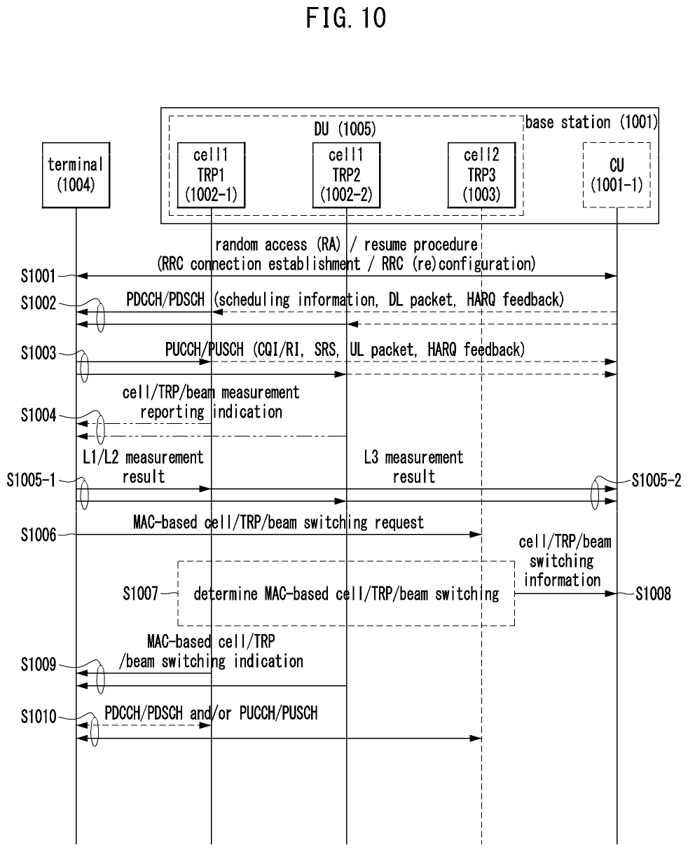

FIG. 10 is a sequence chart illustrating a third exemplary embodiment of a cell/TRP/beam switching procedure in a communication system.

Referring to FIG. 10, a base station 1001 to which the function split scheme is applied may include a CU 1001-1 and a DU 1005. When the function split scheme is not applied to the base station 1001, the base station 1001 may include one or more cells. The DU 1005 of the base station 1001 to which the function split scheme is applied may include one or more cells. The cell may provide a service to a terminal 1004 using one or more TRPs 1002 and 1003. A TRP1 1002-1 and a TRP2 1002-2 may belong to a cell 1, and the TRP3 1003 may belong to a cell 2. The cell 1 and the cell 2 may have different PCIs. The cell 1 and the cell 2 may belong to the same base station or different base stations.

The terminal 1004 in the RRC idle state or the RRC inactive state may perform a radio access procedure with the base station 1001 (S1001). The radio access procedure may include a random access procedure and/or a resume procedure. In the step S1001, the terminal 1004 may transition to the RRC connected state by performing an RRC connection establishment procedure or an RRC connection (re)configuration procedure with the base station 1001 (or CU 1001-1). In the step S1001, the terminal 1004 may monitor and/or measure DL radio channel(s) of the cell(s) (or TRPs) 1002 and 1003, and select the best cell (or TRP) based on a result of the monitoring and/or measurement, and perform the radio access procedure (e.g., random access procedure or resume procedure) using a radio resource of a UL channel, which corresponds to the selected beam.

The terminal 1004 may transmit a DL channel measurement result, service request, and/or capability information (e.g., terminal capability information) to the base station 1001 (or CU 1001-1) in the radio access procedure. The channel measurement result may include a channel quality (e.g., RSRP, RSRQ, RSSI, SNR, SIR, Eb/No, etc.), SSB index, and/or RS index for a signal (e.g., SSB, RS) transmitted by the base station (or cell, TRP) requiring the selection of radio link and/or beam.

The base station 1001 (or CU 1001-1) may receive the channel measurement result for the cell (or TRP) 1002 and 1003, service request, and/or capability information from the terminal 1004, and may generate RRC configuration information required for providing a service requested by the terminal 1004 based on the channel measurement result, service request, and/or capability information. The base station 1001 (or CU 1001-1) may transmit an RRC connection control message (e.g., RRC reconfiguration message, RRC release message, RRC resume message, etc.) including the RRC configuration information to the terminal 1004. The RRC connection control message may include information of configuration parameters of each layer of the radio protocol. The RRC connection control message may be transmitted using the cell (or TRP) and/or beam (or TCI state ID) selected by the terminal 1004. The terminal 1004 may receive the RRC connection control message from the base station 1001 (or CU 1001-1), and may configure parameters of each layer of the radio protocol, which are required for proving the service, by using information included in the RRC connection control message.

In the step S1001, the base station 901 (or CU 1001-1) may provide information on cell(s) and/or TRP(s) providing the service and/or a cell/TRP/beam switching list to the terminal 1004. The cell/TRP/beam switching list may include at least one of information on cell(s) capable of cell switching based on the L1 measurement result and/or L2 measurement result, information on TRP(s) capable of TRP switching based on the L1 measurement result and/or L2 measurement result, or information on beam(s) capable of beam switching based on the L1 measurement result and/or the L2 measurement result. The cell/TRP/beam switching may refer to L1/L2 based cell/TRP/beam switching or MAC based cell/TRP/beam switching.

The DU 1005 may independently perform the cell switching operation, TRP switching operation, and/or beam switching operation. The cell switching may refer to switching between cells belonging to the same DU or different DUs. The TRP switching may refer to switching between TRPs belonging to the same cell and/or switching between TRPs belonging to different cells (e.g., different cells within the same DU or different DUs). The beam switching may refer to switching between beams for the same cell, switching between beams for different cells, switching between beams for the same TRP, and/or switching between beams for different TRPs. When the cell is switched, not only the cell but also the TRP and/or beam may be switched. Therefore, the cell switching operation may mean the TRP switching operation and/or the beam switching operation.

The base station 1001 may allow the switching of the cell(s), TRP(s), and/or beam(s) belonging to the cell/TRP/beam switching list to the terminal 1004 and/or DU 1005 by transmitting the cell/TRP/beam switching list to the terminal 1004 and/or DU 1005. The cell/TRP/beam switching list may include at least one of identifier(s) (e.g., PCI(s)) of the cell(s), identifier(s) of the TRP(s), identifier(s) of the beam(s), or TCI state ID(s). The terminal 1004 may perform a measurement operation (e.g., channel measurement operation) for cell(s)/TRP(s)/beam(s) for which switching is allowed by the base station 1001.

In the step S1001, DC and CA functions may not be configured in the terminal 1004 in the RRC connected state. In this case, the service for the terminal 1004 may be provided by one TRP 1002-1, 1002-2, or 1003 or two TRPs 1002-1 and 1002 belonging to the same cell (e.g., cell 1). The terminal 1004 may identify configuration parameters for the two TRPs 1002-1 and 1002-2 included in the RRC connection control message. In this case, the terminal 1004 may receive PDCCH(s) (e.g., DCI) and/or a PDSCH (e.g., DL packet) from the two TRPs 1002-1 and 1002-2 in step S1002. Scheduling information of the DL packet may be included in the DCI.

In the step S1002, the terminal 1004 may receive the DCI(s) from two the TRPs 1002-1 and 1002-2 based on a single-DCI mode or a multi-DCI mode. In order to improve DCI reception performance, repeated DCI transmission may be performed. The terminal 904 may transmit a PUCCH and/or PUSCH, and the base station 1001 may receive the PUCCH and/or PUSCH from the terminal 1004 (S1003). The step S1003 may be performed identically or similarly to the step S803 in the exemplary embodiment of FIG. 8.

In a step S1004, the DU 1005 (e.g., MAC layer or MAC entity) may determine a specific cell/specific TRP/specific beam for cell/TRP/beam switching, and may indicate, to the terminal 104, L1 measurement, L1 measurement result reporting, L2 measurement, and/or L2 measurement result reporting for the specific cell/specific TRP/specific beam. The DU 1005 may indicate, to the terminal 1004, L1 measurement, L1 measurement result reporting, L2 measurement, and/or L2 measurement result reporting for a cell/TRP/beam belonging to the cell/TRP/beam switching list configured by the base station 1001 (or CU 1001-1). The cell/TRP/beam switching list may be indicated in the RRC connection configuration procedure between the terminal and the base station in the step S1001. Alternatively, the cell/TRP/beam switching list may be indicated in an RRC connection reconfiguration procedure between the terminal and the base station after the step S1001. In other words, the cells/TRPs indicatable by the DU 1005 in the step S1004 may be limited to cells/TRPs/beams belonging to the cell/TRP/beam switching list and/or cells/TRPs/beams independently switchable by the DU 1005. The control message transmitted from the DU 1005 to the terminal 1004 in the step S1004 may include at least one of an identifier of the specific TRP (or target TRP), beam identifier, measurement object identifier, or type of measurement result parameter (or measurement result format), which is a measurement target.

In a step S1004, the terminal 1004 may receive the control message (e.g., cell/TRP/beam measurement reporting indication) from the DU 1005, and may identify information element(s) included in the control message. Based on the RRC control message of the base station 1001 (or CU 1001-1) and/or the control message of the DU 1005 received in the step S1004, the terminal 9104 may perform the measurement operation (e.g., L1 measurement operation and/or L2 measurement operation) for the cell, TRP, and/or beam. The terminal 1004 may periodically or aperiodically report measurement results (e.g., L1 measurement results and/or L2 measurement results) (S1005). The measurement result of the terminal 1004 may be transmitted to the CU 1001-1 through the serving cell/serving TRPs 1002-1 and 1002-2.

In a step S1005-1, the L1 measurement result and/or the L2 measurement result may be reported to the MAC layer (e.g., MAC entity) of the DU 1005. In a step S1005-2, the L3 measurement result may be reported to the RRC layer of the base station 1001 (or CU 1001-1). The L1 measurement result and/or the L2 measurement result reported by the terminal 1004 may include one or more information elements listed in Table 1 above.

The terminal 1004 may transmit a MAC-based cell/TRP/beam switching request message to the DU 1005 through the target cell/target TRP 1003 instead of the serving cell/serving TRPs 1002-1 and 1002-2 (S1006). In the exemplary embodiment of FIG. 9, the MAC-based cell/TRP/beam switching request message is transmitted to the DU 905 through the serving cell/serving TRPs 902-1 and 902-2, but in the exemplary embodiment of FIG. 10, the MAC-based cell/TRP/beam switching request message may be transmitted to the DU 1005 through the target cell/target TRP 1003. When it is determined that the MAC-based cell/TRP/beam switching is to be performed, the DU 1005 may transmit a MAC-based cell/TRP/beam switching response message to the terminal 1004 through the serving cell/serving TRPs 1002-1 and 1002-2 or the target cell/target TRP 1003. The MAC-based cell/TRP/beam switching response message may be a MAC-based cell/TRP/beam switching indication message or a MAC-based cell/TRP/beam switching allowance message. The MAC-based cell/TRP/beam switching response message may be indicative of performing of the MAC-based cell/TRP/beam switching.

The MAC-based cell/TRP/beam switching request message transmitted by the terminal 1004 in the step S1006 may be a physical layer signal and/or a MAC CE (e.g., L2 message or MAC message). The physical layer signal (e.g., L1 message or PHY message) may be at least one of an RA preamble, scheduling request, or uplink reference signal (e.g., SRS). The RA preamble may be an RA preamble in the 4-step RA procedure and/or an RA preamble in the 2-step RA procedure. The scheduling request may be a separately configured scheduling request to request the MAC-based cell/TRP/beam switching. The MAC CE may be an L2 message in the RA procedure. The L2 message may be a Msg3 in the 4-step RA procedure or a MsgA payload (e.g., MsgA-PUSCH) in the 2-step RA procedure. Alternatively, the MAC CE may be a MAC CE configured separately to request the MAC-based cell/TRP/beam switching.

A radio resource for transmission of the MAC-based cell/TRP/beam switching request message (e.g., physical layer signal and/or MAC CE) may be allocated in advance in the RRC connection (re)configuration procedure of the step S1001 and/or an RRC connection reconfiguration procedure for the terminal 1004 after the step S1001. When transmission of the MAC-based cell/TRP/beam switching request message is performed based on the RA procedure, the base station 1001 may transmit RACH configuration information to the terminal, so that the terminal 1004 can transmit the MAC-based cell/TRP/beam switching request message according to a contention free random access (CFRA) scheme. The transmission of the RACH configuration information may be performed in the step S1001. The RACH configuration information may include RA occasion (RO) resource information, and the RA resource information may include an RA preamble index. For the MAC-based cell/TRP/beam switching procedure, the base station 1001 may allocate and transmit CFRA-type RACH configuration information for a plurality of cells to the terminal 1004.

When the MAC-based cell/TRP/beam switching request message is a physical layer signal, the base station 1001 may allocate a radio resource for transmission of the physical layer signal to the terminal 1004. An operation of allocating the radio resource for transmission of the physical layer signal may be performed in the step S1001. Allocation information of the radio resource for transmission of the physical layer signal may include an index for identifying the physical layer signal, time resource allocation information for transmission of the physical layer signal, and/or frequency resource allocation information for transmission of the physical layer signal.

When a CFRA resource for transmission of the MAC-based cell/TRP/beam switching request message and/or a resource for the physical layer signal is not allocated, the terminal 1004 may perform the step S1006 using a contention-based random access (CBRA) procedure. In this case, the MAC-based cell/TRP/beam switching request message may be at least one of a Msg3 of the 4-step RA procedure, MsgA-payload (e.g., MsgA-PUSCH) of the 2-step RA procedure, or MAC CE. The MAC CE may be a MAC CE configured separately for the MAC-based cell/TRP/beam switching request. In the step S1006, the MAC-based cell/TRP/beam switching request message may include a scheduling identifier (e.g., cell-radio network temporary identifier (C-RNTI)) assigned to the terminal 1004. When a preconfigured condition is satisfied, the terminal 1004 may transmit the MAC-based cell/TRP/beam switching request message in the step S1006. The condition for transmitting the MAC-based cell/TRP/beam switching request message may be informed to the terminal 1004 through system information and/or an RRC connection (re)configuration message. The RRC connection (re)configuration message may be transmitted in the step S1001. The conditions for transmission of the MAC-based cell/TRP/beam switching request message may include one or more conditions listed in Table 2 above.

The DU 1005 may receive the MAC-based cell/TRP/beam switching request message from the terminal 1004. The DU 1005 may determine whether to perform MAC-based cell/TRP/beam switching according to the request of the terminal 1004 (S1007). When it is determined in the step S1007 that the MAC-based cell/TRP/beam switching is to be performed, the DU 1005 may transmit a control message (e.g., control information) notifying that the MAC-based cell/TRP/beam switching is to be performed to the base station 1001 (or CU 1001-1) (S1008). The control message transmitted in the step S1008 may include information on the terminal 1004 and/or information on the cell/TRP/beam switching.

When it is determined in the step S1007 that the MAC-based cell/TRP/beam switching is to be performed, the DU 1005 may transmit a response message indicative of performing the MAC-based cell/TRP/beam switching to the terminal 1004 (S1009). When the step S1006 is performed based on the CFRA procedure or CBRA procedure, the MAC-based cell/TRP/beam switching response message in the step S1009 may be an RA response message. The MAC-based cell/TRP/beam switching response message may include information indicating whether the MAC-based cell switching is allowed. When it is determined in the step S1007 that the MAC-based cell/TRP/beam switching is not to be performed, the DU 1005 may transmit a MAC-based cell/TRP/beam switching response message indicating rejection of the MAC-based cell/TRP/beam switching request to the terminal 1004 (S1009).

In the step S1009, the MAC-based cell/TRP/beam switching response message may be transmitted to the terminal 1004 through the serving cell/serving TRPs 1002-1 and 1002-2 or the target cell/target TRP 1003. When the MAC-based cell/TRP/beam switching response message is transmitted to the terminal 1004 through the serving cell/serving TRPs 1002-1 and 1002-2 in the step S1009, the MAC-based cell/TRP/beam switching response message may be transmitted to the terminal 1004 using a scheduling identifier assigned by the serving cell 1002-1 or 1002-2. The MAC-based cell/TRP/beam switching response message may be a DCI.

Alternatively, in the step S1009, the MAC-based cell/TRP/beam switching response message may be transmitted to the terminal 1004 through the target cell/target TRP 1003. When the MAC-based cell/TRP/beam switching response message is transmitted in form of an RA response message, the MAC-based cell/TRP/beam switching response message may include a scheduling identifier assigned by the target cell/target TRP 1003 to the terminal 1004. When the MAC-based cell/TRP/beam switching response message is transmitted to the terminal 1004 through the target cell/target TRP 1003 in a form different from an RA response message, the scheduling identifier of the target cell/target TRP 1003 may be assigned in advance to the terminal 1004 in the step S1001 and/or when the multi-TRP function for the terminal 1004 is determined to be supported. When the scheduling identifier of the target cell/target TRP 1003 is assigned in advance to the terminal 1004, in the step S1009, the DU 1005 may transmit the MAC-based cell/TRP/beam switching response message through the cell/target TRP 1003 by using the preassigned scheduling identifier.

In the step S1009, the terminal 1004 may receive the MAC-based cell/TRP/beam switching response message (e.g., message indicating the MAC-based cell/TRP/beam switching) from the DU 1005. In this case, the terminal 1004 may release resources (e.g., radio resources) configured for the serving cell/serving TRPs 1002-1 and 1002-2, and may perform communication with the target cell/target TRP 1003 by using radio resources (or scheduled resources) for the target cell/target TRP 1003 (S1010). In other words, in the step S1010, the target cell/target TRP 1003 may provide a service to the terminal 1004. The target cell/target TRP 1003 may operate as a serving cell/serving TRP for the terminal 1004 in the step S1010.

In the exemplary embodiments of FIGS. 8 to 10, the DU may perform at least one of the cell change operation, TRP change operation, or beam change operation based on the request from the terminal and/or measurement result report from the terminal. In this case, configuration value(s) of MAC layer parameter(s) and/or variable(s) in the MAC entity for the terminal may be synchronized. Alternatively, configuration value(s) of the MAC layer parameter(s) and/or variable(s) in the MAC entity for the terminal may have continuity. In other words, the configuration value(s) of MAC layer parameter(s) and/or variable(s) in the MAC entity for the terminal may be maintained. Each of the cell change operation, TRP change operation, and beam change operation may be performed based on the MAC layer.

Configuration value(s) of parameter(s) and/or variable(s) configured for each cell by the RRC layer may be reset. In the step S805, S906, or S1007, the DU may determine to change the cell, TRP, and/or beam. The cell, TRP, and/or beam change operation in the step S805, S906, or S1007 may be the MAC-based change operation (e.g., switching operation). The DU may transmit information related to the cell, TRP, and/or beam change to the base station (e.g., CU) (S806, S907, S1008).

When each of the steps S806, S907, and S1008 is performed, configuration parameter(s), RRC layer parameter(s), and/or L1/L2 layer (e.g., PHY layer, MAC layer, RLC layer) parameter(s) for each cell for the terminal may be newly configured between the DU and the base station (e.g., CU). The DU may transmit a control message (e.g., separate control message) including the newly configured parameters to the terminal. The control message may indicate the cell, TRP, and/or beam switching. The switching operation indicated by the control message may be the MAC-based switching operation.

In the cell, TRP, and/or beam switching operations (e.g., MAC-based switching operations) described in FIGS. 8 to 10, one MAC entity may be configured in the terminal. The switching operation may be for supporting and operating the multi-TRP function.

An improved TRP/beam switching method may be required to provide a service without packet loss while the terminal performs a switching operation to a TRP (or beam) belonging to another base station and/or another cell. For one terminal in which the DC function is not configured, a switching operation using configuration of two MAC entities may be considered.

Two MAC entities configured in the terminal that does not support the DC function may include a primary-MAC (or active-MAC) and a candidate-MAC (or inactive-MAC or configured-MAC). The primary-MAC may be referred to as a P-MAC, and the candidate-MAC may be referred to as a c-MAC. The P-MAC may be a MAC entity configured (or generated) for the serving cell/serving TRP/serving beam. The c-MAC may be a MAC entity configured (or generated) for the target cell/target TRP/target beam.

The P-MAC may be generated in the step of establishing or configuring an RRC connection between the terminal and the base station (e.g., CU). The c-MAC may be generated in the step in which the multi-TRP function support and the RRC connection reconfiguration are performed for the terminal.

Simultaneous activation of the P-MAC and c-MAC for one terminal may be restricted. In other words, simultaneous operations of the P-MAC and c-MAC for one terminal may be restricted. In this case, a terminal supporting the multi-TRP function may perform a MAC layer control function based on one of the two MAC entities.

Alternatively, a method in which both the P-MAC and the c-MAC are activated (e.g., operated) for a preconfigured time period (e.g., an operation period of a timer) may be applied. For example, the P-MAC for the serving cell/serving TRP/serving beam may be released after completion of the cell/TRP/beam switching operation or at a time when resources of the serving cell/serving TRP/serving beam for the terminal are released. The c-MAC for the target cell/target TRP/target beam may be activated at a time when the cell/TRP/beam switching operation to the target cell/target TRP/target beam is triggered. In other words, the c-MAC for the target cell/target TRP/target beam may be operated at a time when the cell/TRP/beam switching operation to the target cell/target TRP/target beam is triggered. The time at which the cell/TRP/beam switching operation is triggered may be a time when the terminal transmits the cell/TRP/beam switching request message, a time when the base station (e.g., DU) receives the cell/TRP/beam switching request message from the terminal, or a time when the base station (e.g., DU) transmits the cell/TRP/beam switching response message (e.g., message indicating the cell/TRP/beam switching).

To support the multi-TRP function, the two MAC entities may be generated, and the MAC-based cell/TRP/beam switching operations may be performed. In this case, configuration values of MAC layer parameters and/or variables may be synchronized between the P-MAC and the c-MAC. In other words, in configuring the MAC layer parameters and/or variables between the P-MAC and the c-MAC, initial configuration of the c-MAC for a scheduling identifier (e.g., RNTI-based identifier such as C-RNTI), HARQ identifier, logical channel identifier, configuration of parameters and variables of TCI state configuration information, and/or PUCCH/CORESET configuration parameter(s) may be configured by being copied from those of the P-MAC or by being maintained as the same values as those of the P-MAC without change. The configuration value(s) of the parameters and/or variables configured by the RRC layer for each cell may be reset.

In the present disclosure, the radio channel quality may be a channel state indicator (CSI), a received signal strength indicator (RSSI), a reference signal received power (RSRP), a reference signal received quality (RSRQ), or a signal to interference and noise ratio (SINR). With respect to the operation of the timer defined or described in the present disclosure, although operations such as start, stop, reset, restart, or expire of the defined timer are not separately described, they mean or include the operations of the corresponding timer or a counter for the corresponding timer. The terminal may refer to a UE, a terminal, an access terminal, a mobile terminal, a station, a subscriber station, a mobile station, a portable subscriber station, a node, a device), an Internet of Thing (IoT) device, or a mounted apparatus (e.g., a mounted module/device/terminal or an on-board device/terminal).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
performing a measurement operation on a radio channel;
transmitting a result of the measurement operation to a serving cell;
receiving a cell switching indication message from the serving cell; and
performing communication with a target cell based on the cell switching indication message,
wherein a cell switching operation according to the cell switching indication message is a medium access control (MAC)-based cell switching operation without radio resource control (RRC) reconfiguration.

2. The method according to claim 1, wherein each of the serving cell and the target cell includes one or more transmission and reception points (TRPs), and the serving cell and the target cell belong to a same base station or different base stations.

3. The method according to claim 1, wherein the cell switching operation means a TRP switching operation or a beam switching operation.

4. The method according to claim 1, further comprising: receiving a cell switching list from a base station to which the serving cell belongs, wherein the measurement operation is performed on one or more cells indicated by the cell switching list.

5. The method according to claim 4, wherein the cell switching list includes at least one of a cell identifier, a TRP identifier, a beam identifier, or a transmission configuration indicator (TCI) state identifier (ID).

6. The method according to claim 1, further comprising: transmitting a cell switching request message to the target cell after performing the measurement operation, wherein the cell switching request message is transmitted together with the result of the measurement operation or transmitted after transmitting the result of the measurement operation, and the cell switching request message is a layer 1 (L1) message or a layer2 (L2) message.

7. The method according to claim 6, wherein the L1 message is a random access (RA) preamble, a scheduling request, or an uplink reference signal.

8. The method according to claim 6, wherein the L2 message is a Msg3 in a 4-step RA procedure or a MsgA payload in a 2-step RA procedure.

9. The method according to claim 6, wherein a radio resource for transmission of the cell switching request message is pre-allocated in an RRC connection configuration procedure or an RRC connection reconfiguration procedure between a base station to which the serving cell belongs and the terminal.

10. The method according to claim 1, wherein the cell switching indication message is a MAC control element (CE) or downlink control information (DCI).

11. The method according to claim 1, wherein the cell switching indication message includes at least one of information indicative of performing an operation of acquiring an uplink timing, information of the uplink timing, scheduling information, an identifier of the target cell, an identifier of a target TRP associated with the target cell, an identifier of a target beam associated with the target cell, an identifier of a serving beam associated with the serving cell, or combinations thereof.

12. The method according to claim 1, further comprising, when the cell switching indication message is received, performing an operation of acquiring an uplink timing for the target cell.

13. A method of a base station, comprising:
receiving, from a terminal, a result of a measurement operation on a radio channel;
determining whether to perform a cell switching operation based on the result of the measurement operation; and
in response to determining that the cell switching operation is to be performed, transmitting a cell switching indication message to the terminal,
wherein the result of the measurement operation is received by a serving cell belonging to the base station, the cell switching indication message is transmitted by the serving cell, the serving cell includes one or more transmission and reception points (TRPs), and the cell switching operation is a medium access control (MAC)-based cell switching operation without radio resource control (RRC) reconfiguration.

14. The method according to claim 13, further comprising: transmitting a cell switching list to the terminal, wherein the measurement operation of the terminal is performed on one or more cells indicated by the cell switching list.

15. The method according to claim 14, wherein the cell switching list includes at least one of a cell identifier, a TRP identifier, a beam identifier, or a transmission configuration indicator (TCI) state identifier (ID).

16. The method according to claim 13, further comprising: receiving a cell switching request message from the terminal, wherein the cell switching request message is a layer 1 (L1) message or a layer2 (L2) message.

17. The method according to claim 16, wherein the L1 message is a random access (RA) preamble, a scheduling request, or an uplink reference signal, and the L2 message is a Msg3 in a 4-step RA procedure or a MsgA payload in a 2-step RA procedure.

18. The method according to claim 16, wherein a radio resource for transmission of the cell switching request message is pre-allocated in an RRC connection configuration procedure or an RRC connection reconfiguration procedure between the base station and the terminal.

19. The method according to claim 13, wherein the cell switching indication message is a MAC control element (CE) or downlink control information (DCI).

20. The method according to claim 13, wherein the cell switching indication message includes at least one of information indicative of performing an operation of acquiring an uplink timing, information of the uplink timing, scheduling information, an identifier of the target cell, an identifier of a target TRP associated with the target cell, an identifier of a target beam associated with the target cell, an identifier of a serving beam associated with the serving cell, or combinations thereof.
